(19) United States
(12) Patent Application Publication
(10) Pub. No.: US 2018/0341937 A1
(43) Pub. Date: Nov. 29, 2018

(54) METHOD AND APPARATUS FOR PERFORMING SETTLEMENT TRANSACTION

(71) Applicant: Samsung Electronics Co., Ltd., Suwon-si, Gyeonggi-do (KR)

(72) Inventors: Jong-Su KIM, Suwon-si (KR); Da-Som LEE, Seoul (KR); Sun-Kee LEE, Seongnam-si (KR); Seong-Min JE, Suwon-si (KR)

(21) Appl. No.: 15/755,924

(22) PCT Filed: Sep. 1, 2016
(86) PCT No.: PCT/KR2016/009795

§ 371 Date: Feb. 27, 2018

(30) Foreign Application Priority Data
Sep. 1, 2015 (KR) 10-2015-0123740

(51) Int. Cl. G06Q 20/16; H04L 9/00

(52) U.S. Cl. CPC G06Q 20/16; H04L 9/00

(57) ABSTRACT

An electronic apparatus and a method for performing a settlement transaction in an electronic apparatus, according to various embodiments of the present invention, can transmit, to a settlement apparatus, settlement data, which is generated by using authentication information, in response to a settlement request inputted through the electronic apparatus; check whether a settlement response message including result information of a settlement performance using the settlement data is received; and manage stored authentication information according to whether the settlement response message is received within a predetermined time period. Also, other various embodiments are possible.

### TECHNICAL FIELD

Various embodiments of the present disclosure relate to a method and a device for performing a payment transaction.

### BACKGROUND ART

A variety of recently used electronic devices have been developed so as to use various functions related to applications. For example, an application may be executed in an electronic device (e.g., a smart phone), and payment may be performed by means of the electronic device.

A variety of recently used electronic devices have been developed so as to use various functions. These electronic devices are provided with a display in order to more effectively use various functions. For example, the latest smart phones are provided with a display (e.g., a touch screen) that is sensitive to a touch on the front surface of the device.

In addition, various applications (also referred to as “Apps”) may be installed and executed in the electronic device. Various input means (e.g., a touch screen, a button, a mouse, a keyboard, sensors, or the like) may be used in order to execute and control the applications in the electronic device.

### DETAILED DESCRIPTION OF THE INVENTION

### Technical Problem

In the case where a payment transaction is performed using an electronic device, data transmission (e.g., magnetic data transmission) can be made only in unilateral direction. Accordingly, the user of the electronic device may have difficulty in confirming the feedback from a receiving node, which indicates whether or not the data has been normally transmitted or received.

### Technical Solution

In accordance with an aspect of the present disclosure, an electronic device may include: at least one communication circuit; a memory configured to store verification information; and a processor configured to perform control so as to transmit, to a payment device, payment data, which is generated using the verification information, through a first communication circuit in response to a payment request input through the electronic device, configured to check whether or not a payment response message including information related to payment execution using the payment data is received through a second communication circuit, and configured to manage the stored verification information depending on whether or not the payment response message is received within a predetermined time.

In accordance with another aspect of the present disclosure, a server for managing payment may include: a processor configured to, when a first payment data is received from an external electronic device, identify first verification information included in the received first payment data, configured to determine whether or not it is possible to execute the payment corresponding to the first payment data using the first verification information, and configured to perform control so as to transmit the determined result to the external electronic device; and a memory configured to store at least one piece of verification information.

In accordance with another aspect of the present disclosure, a method of performing a payment transaction in an electronic device may include: transmitting, to a payment device, payment data, which is generated using verification information in response to a payment request input through the electronic device; checking whether or not a payment response message including payment execution result information using the payment data is received; and managing stored verification information depending on whether or not the payment response message is received within a predetermined time.

In accordance with another aspect of the present disclosure, a method of performing a payment transaction in an electronic device may include: when a first payment data is received from an external electronic device, identifying first verification information included in the received first payment data; determining whether or not it is possible to execute the payment corresponding to the first payment data using the first verification information; and transmitting the determined result to the external electronic device.

### Advantageous Effects

In an electronic device and a method of performing a payment transaction in the electronic device, according to various embodiments of the present disclosure, when payment transaction data is transmitted to the electronic device, the electronic device makes a request to a server, which has received data included in the payment transaction data, for confirmation on whether or not the payment transaction data is normally transmitted and receives a response thereto. Therefore, it is possible to confirm the feedback on the payment transaction data in the electronic device.

### BRIEF DESCRIPTION OF DRAWINGS

The above and other aspects, features, and advantages of the present disclosure will be more apparent from the following detailed description taken in conjunction with the accompanying drawings, in which:

FIG. 1 is a view illustrating an example of a communication system, according to various embodiments of the present disclosure;

FIG. 2 is a view illustrating an example of a screen for performing payment using an electronic device, according to various embodiments of the present disclosure;

FIG. 3 is a view illustrating an example of a payment system, according to various embodiments of the present disclosure;

FIG. 4 is a block diagram illustrating an example of a token structure, according to various embodiments of the present disclosure;

FIG. 5 is a view illustrating an example of a payment system, according to various embodiments of the present disclosure;

FIG. 6 is a view illustrating an example of issuing a token and performing payment using the issued token in a payment system, according to various embodiments of the present disclosure;

FIG. 7 is a flowchart illustrating an example of an operation of confirming the use of a token in a payment system, according to various embodiments of the present disclosure;

FIG. 8 is a block diagram illustrating an example of the configuration of an electronic device, according to various embodiments of the present disclosure;

FIG. 9 is a block diagram illustrating an example of the configuration of an electronic device, according to various embodiments of the present disclosure;

FIGS. 10A to 10C are block diagrams illustrating various examples of a TEE, according to various embodiments of the present disclosure;

FIG. 11 is a block diagram illustrating an example of circuits that can be executed in an execution environment of an electronic device capable of performing a payment function, according to various embodiments of the present disclosure;

FIG. 12 is a block diagram illustrating an example of a structure of a payment server, according to various embodiments of the present disclosure;

FIG. 13 is a view illustrating an example of a structure of a server, according to various embodiments of the present disclosure;

FIG. 14 is a flowchart illustrating an example of a payment operation, according to various embodiments of the present disclosure;

FIG. 15 is a flowchart illustrating an example of an operation for transmitting a notification of token usage in a server, according to various embodiments of the present disclosure;

FIG. 16 is a flowchart illustrating an example of an operation for transmitting a notification of token usage in a server, according to various embodiments of the present disclosure;

FIG. 17 is a flowchart illustrating an example of a payment operation in a payment system, according to various embodiments of the present disclosure;

FIG. 18 is a flowchart illustrating an example of a key requesting operation in a payment system, according to various embodiments of the present disclosure;

FIG. 19 is a flowchart illustrating an example of an operation in which an electronic device manages user identification information, according to various embodiments of the present disclosure;

FIG. 20 is a flowchart illustrating an example of an operation for managing a key according to payment approval in a payment system, according to various embodiments of the present disclosure;

FIG. 21 is a flowchart illustrating an example of an operation for managing a key according to payment approval in a payment system, according to various embodiments of the present disclosure;

FIG. 22 is a flowchart illustrating an example of an operation for managing a key according to payment approval in a payment system, according to various embodiments of the present disclosure;

FIG. 23 is a flowchart illustrating an example of an operation for managing a key according to payment approval in an electronic device, according to various embodiments of the present disclosure;

FIG. 24 is a flowchart illustrating an example of an operation for managing a new user key according to payment approval in a server, according to various embodiments of the present disclosure;

FIG. 25 is a flowchart illustrating an example of an operation for managing a new key according to payment approval in a server, according to various embodiments of the present disclosure;

FIG. 26 is a flowchart illustrating an example of an operation for managing a new key according to payment approval in a payment system, according to various embodiments of the present disclosure;

FIG. 27 is a flowchart illustrating an example of an operation for managing a new key according to payment approval in an electronic device, according to various embodiments of the present disclosure;

FIG. 28 is a flowchart illustrating an example of an operation for managing a new key according to payment approval in a server, according to various embodiments of the present disclosure;

FIG. 29 is a flowchart illustrating an example of an operation for managing a new key according to payment approval in a server, according to various embodiments of the present disclosure;

FIG. 30 is a view illustrating an example of the operation of a payment system, according to various embodiments of the present disclosure;

FIG. 31 is a view illustrating an example of a payment system, according to various embodiments of the present disclosure;

FIG. 32 is a view illustrating an example of a payment system, according to various embodiments of the present disclosure;

FIG. 33 is a view illustrating an example of a network environment, according to various embodiments of the present disclosure;

FIG. 34 is a block diagram illustrating an example of the configuration of an electronic device, according to various embodiments of the present disclosure; and

FIG. 35 is a block diagram illustrating an example of a program circuit, according to various embodiments of the present disclosure.

### MODE FOR CARRYING OUT THE INVENTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first electronic device and a second electronic device may indicate different user devices regardless of order or importance thereof. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., Central Processing Unit (CPU) or Application Processor (AP)) that can perform the corresponding operations by executing one or more software programs stored in a memory device.

The terms used herein are merely for the purpose of describing particular embodiments and may not be intended to limit the scope of other embodiments. A singular expression may include a plural expression unless they are definitely different in a context. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an Automatic Teller's Machine (ATM) in banks, Point Of Sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). In various embodiments, the electronic device may be a combination of one or more of the aforementioned various devices. According to some embodiments, the electronic device may also be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

A payment system, according to various embodiments of the present disclosure, may request payment approval by transmitting, to a financial server, payment data related to the payment requested by an electronic device through a payment network in order to thereby perform payment.

According to various embodiments of the present disclosure, the payment data may include a variety of information related to payment execution, such as payment amount, payment time, card information, payment details, and the like. For example, card information {e.g., A primary Account Number (PAN) or verification information corresponding to the PAN} may be transmitted over a communication network such as magnetic stripe data communication, NFC, or the like.

According to various embodiments of the present disclosure, the payment may include an operation of paying a charge on goods or services or trading goods or services, and may include various other operations for processing the payment for goods or services.

A payment server, according to various embodiments of the present disclosure, which is at least one server related to payment using an electronic device, may include a token requester server, a payment service server, a payment application server, or a management server in relation to a user account, and may further include various other servers related to payment.

According to various embodiments of the present disclosure, verification information is intended to verify card information and to perform payment using the corresponding card information, and may include information about a token corresponding to the card information (e.g., a PAN), encryption information for encrypting the token, or key information for decrypting the token, and the like.

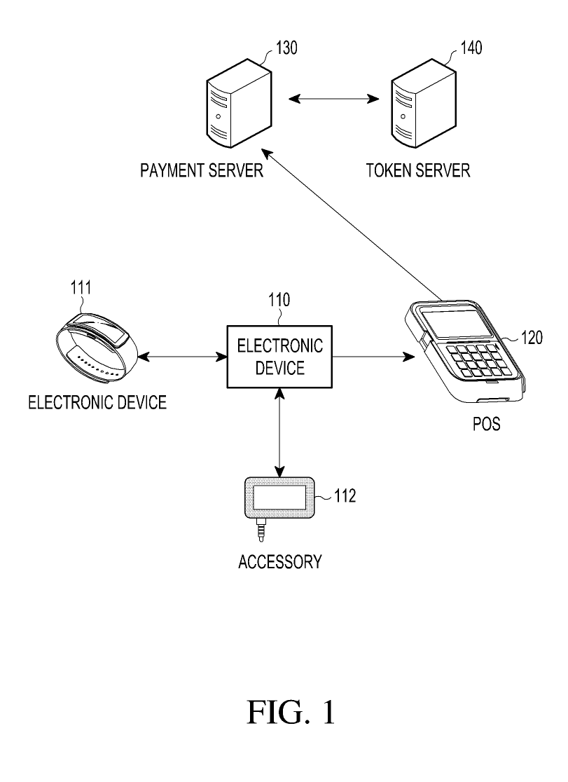

FIG. 1 is a view illustrating an example of a communication system, according to various embodiments of the present disclosure.

Referring to FIG. 1, a communication system 100 may include an electronic device 110, a payment device {e.g., point of sale (POS)} 120, a payment server 130, a token server 140, or other servers (not shown).

According to various embodiments of the present disclosure, the payment system may include one or more extra electronic devices (e.g., a wearable device 111 or an accessory 112). The one or more extra electronic devices may include a wearable device 111 (e.g. a smart watch) or an accessory 112 (e.g. a device in the form of a fob of LoopPay™) that can be operatively connected to (for example, communicate with) the electronic device 110.

According to various embodiments of the present disclosure, the accessory 112 may include an external payment module or circuit, and may be operatively connected to the electronic device 110 through an input/output interface (e.g., a microphone or earphone terminal) thereof.

The electronic device 110 may perform a payment function. For example, the electronic device 110 may register card information (e.g., a credit card such as MasterCard or Visa) in the electronic device 110 or the payment server 130 in order to perform a payment function.

According to various embodiments of the present disclosure, the electronic device 110 may perform payment using at least one of other electronic devices 750 or 760 operatively connected based on short-range communication (e.g., Bluetooth or Wi-Fi). For example, when the electronic device 110 and the wearable device 111 (e.g., a smart watch) are connected with each other, a token transmitted from the token server 140 may be transferred to the wearable device 111.

The POS 120 may include an MST reader, and may recover data (e.g., payment data) by detecting a magnetic-field signal input through the MST reader and converting the detected magnetic-field signal into an electric signal.

According to various embodiments of the present disclosure, the electronic device 110 may share at least one piece of payment data with the wearable device 111 or the accessory 112. For example, information about at least one card may be stored in both the wearable device 111 and the electronic device 110. According to an embodiment, the electronic device may store different card information, which is generated from the same card information, in the wearable device 111 and the accessory 112, respectively. For example, a first token issued from first card information may be stored in the electronic device 110 and a second token issued from the first card information may be stored in the wearable device 111 or the accessory 112.

According to various embodiments of the present disclosure, in the case where the tokens issued from the same card information are stored in different devices (e.g., the electronic device 110, the wearable device 111, or the accessory 112), when a payment circuit in one device is activated, payment circuits in other devices may be deactivated. For example, if a first token among the tokens issued from the first card information is stored in the electronic device 110 and a second token among the same is stored in the wearable device 111 or the accessory 112, the payment of the electronic device 110 may be deactivated when the payment is made using the wearable device 111 or the accessory 112, and the payment of the wearable device 111 or the accessory 112 may be deactivated when the payment is made using the electronic device 110.

The payment server 130 may include an account server for managing account-related information or a token requester server for providing payment-related information. The account server and the token requester server may be implemented as separate devices, or may be included in a single device.

According to various embodiments of the present disclosure, the payment server 130 may manage information on a plurality of registered cards including cards registered through the electronic device 110, cards registered through another electronic device 110 (e.g., the electronic device 111) of the user corresponding to the electronic device 110, and other cards registered through one or more electronic devices of the user.

According to various embodiments of the present disclosure, the payment server 130 may obtain token information corresponding to the registered card information from the token server 140 to thus transmit the same to the electronic device 110.

Referring to FIG. 1, although the payment server 130 is illustrated as a separate element from the token server 140, the payment server 130 may include some elements of the token server 140 {e.g., a token requester server (not shown)}. In this case, the payment server 130 may make a request to the token server 140 for issuing a token.

According to various embodiments of the present disclosure, the payment server 130 may include a payment service server that manages user card information and provides services related to the payment of the corresponding user through a user account.

When token information necessary for a payment operation is requested, the token server 140 may issue a token to be used in the payment operation. The token may be generated through primary account number (PAN) information or bank identification number (BIN) information, which is card information.

According to various embodiments of the present disclosure, the token server 140 may generate or encrypt a token. For example, a token generated or encrypted by the token server 140 may be transmitted to the electronic device 110 without passing through the payment server 130. The generated token may be encrypted by the token server 140, or may be transmitted to the payment server 130 while not being encrypted and may then be encrypted by the payment server 130. The encrypted token information may be transferred to the electronic device 110 through the payment server 130, and then may be decrypted therein.

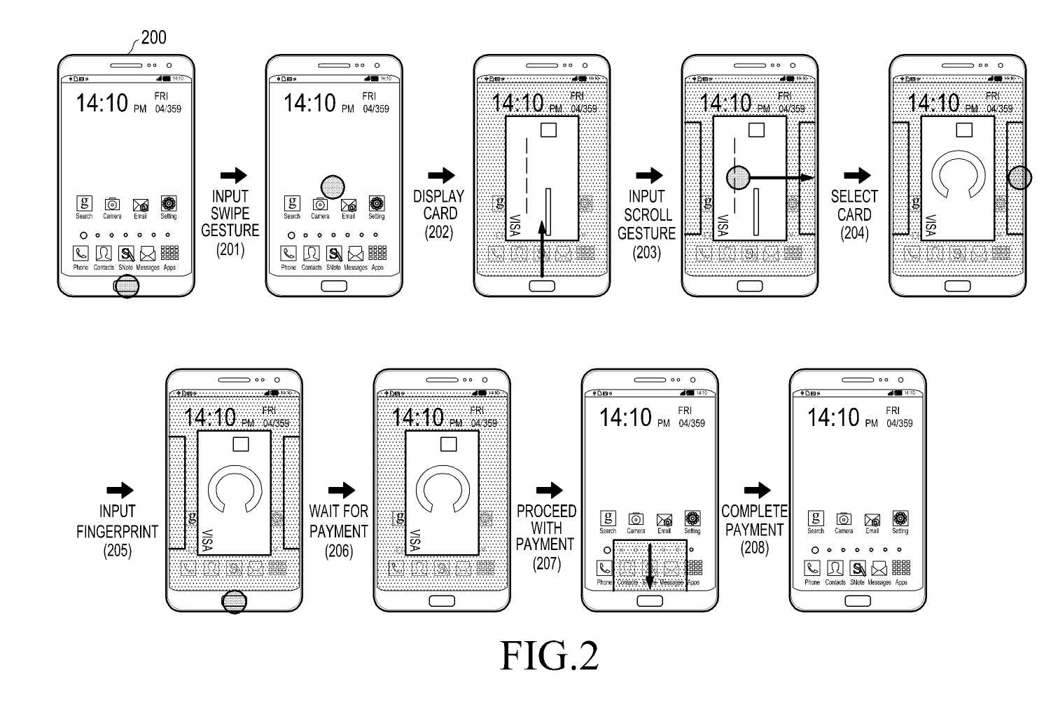

FIG. 2 is a view illustrating an example of a screen for performing payment using an electronic device, according to various embodiments of the present disclosure.

According to various embodiments of the present disclosure, the electronic device 200 may perform payment using a magnetic card in response to a predetermined user input.

Referring to FIG. 2, in operation 201, the electronic device may detect a predetermined user input (e.g., a swipe gesture). For example, the user input may vary depending on manufacturers or user settings.

In operation 202, the electronic device may display one or more payment means in response to the detection of the predetermined user input. For example, the one or more payment means may be displayed to be arranged in the order of the frequency of usage by the user or in accordance with a user setting.

In operation 203, the electronic device may control the display of the payment means (e.g., a magnetic card) according to a user input (e.g., a scroll gesture). For example, the electronic device may display various payment means for the user depending on the direction and type of the user input.

According to various embodiments of the present disclosure, the payment means may be generated to correspond to a real magnetic card, or may be generated to have new identification information corresponding to the card so as to be used in the electronic device.

In operation 204, the user may select a card to be used as payment means by entering a user input (a scroll gesture).

In operation 205, the user may input user information (e.g., a fingerprint) for payment.

When the user information is input, the electronic device may wait for payment, and may determine whether or not the user information matches the user of the payment means in operation 206

If it is determined that the input user information is valid, the electronic device may proceed with payment using the payment means selected by the user in operation 207. For example, the electronic device may transmit information about the selected payment means to the server.

In operation 208, the electronic device may confirm the execution result of the payment received from the server to thus complete the payment. For example, the execution result of the payment may include payment success, payment failure, or a usage result of verification information.

According to various embodiments of the present disclosure, the electronic device may display the execution result of the payment in the form of a message such as an SMS message, a notification message, or the like.

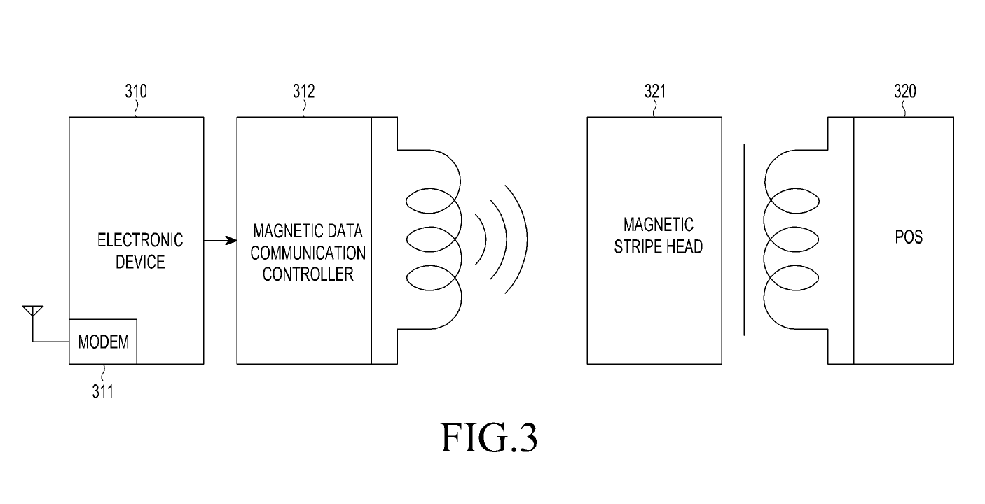

FIG. 3 is a view illustrating an example of a payment system, according to various embodiments of the present disclosure.

Referring to FIG. 3, the payment system may include an electronic device 310 and a payment device (e.g., a POS) 320.

The electronic device 310 may include a modem 311 for communication with an external device, and may include a magnetic communication data controller 312 or may be electrically connected thereto.

The magnetic data communication controller 312 may generate magnetic data (e.g., an electromagnetic-field signal) by swiping of a magnetic card on a magnetic stripe head 321, and may transmit the same to the payment device (e.g., a POS) 320. For example, the generated magnetic data may be transmitted to the POS 320 through induction of a coil connected to the magnetic data communication controller 312.

According to various embodiments of the present disclosure, the magnetic data communication controller 312 may generate magnetic data related to payment data. For example, the payment data may include card information.

According to various embodiments of the present disclosure, when a payment request is received (for example, when the operation 207 of FIG. 2 is performed), the magnetic data communication controller 312 may generate and transmit magnetic data corresponding to the card information selected by the user for payment.

The PoS 320 may include a magnetic stripe head 321.

When the electromagnetic-field signal generated from the electronic device 310 is induced to a coil included in the PoS 320 through the magnetic stripe head 321, the PoS 320 may determine that the magnetic card has been swiped.

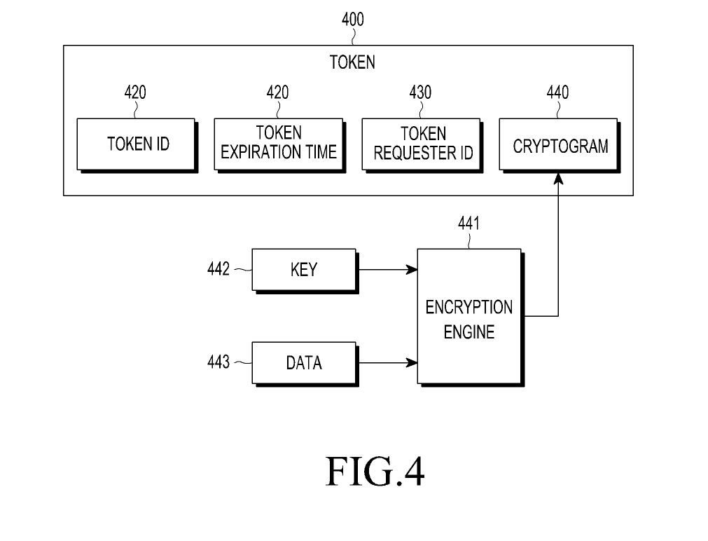

FIG. 4 is a block diagram illustrating an example of a token structure, according to various embodiments of the present disclosure.

Referring to FIG. 4, the token 400 may include a token ID 410, a token expiration time 420, a token requester ID 430, and a cryptogram 440.

The token ID 410 may include identification information of the token 400.

The token expiration time 420 may include information related to the time at which the token 400 for usage expires.

The token requester ID 430 may include identification information related to a server or electronic device requesting the token 400.

The cryptogram 440 may include information related to the encryption of the token 400, and the token 400 may be encrypted in a variety of ways according to the implementation of an encryption engine 441. For example, the cryptogram 440 may be generated by inputting a key 442 for decrypting the token 400 or data 443 related to encryption into the encryption engine 441.

According to various embodiments of the present disclosure, the token 400 may be issued by a server (e.g., the token server 140), and the server may transmit the issued token 400 and key 442 to the electronic device (e.g., the electronic device 110) that has requested the token.

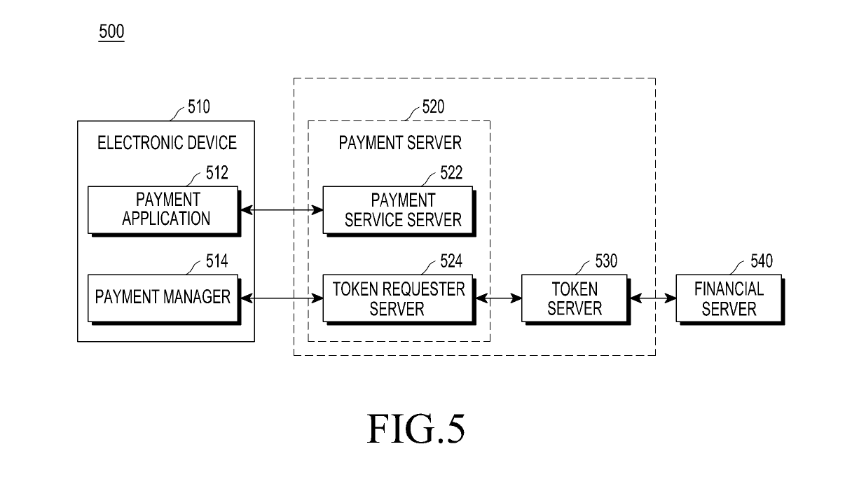

FIG. 5 is a view illustrating an example of a payment system, according to various embodiments of the present disclosure.

Referring to FIG. 5, the payment system 500 may include an electronic device 510 or one or more servers. The servers may include a payment server 520, a token server (e.g., a token service provider) 530, or a financial server (issuer) 540.

The electronic device 510 may include a payment application (wallet application) 512 and/or a payment manager 514.

The payment application 512, for example, may include Samsung Pay™. The payment application 512 may provide a user interface (UI) {or user experience (UX)} in relation to payment. The user interface related to payment may include a wallet user interface (UI/UX). For example, the payment application 612 may provide a user interface related to card registration through a character reader {e.g., an optical character reader/recognition (OCR)} or an external input (e.g., a user input), payment, or transaction, or may provide an user interface related to user identification and verification.

According to various embodiments of the present disclosure, the payment application 512 may perform a payment transaction. For example, the payment application 512 may provide a payment function to a user when a predetermined user input (e.g., Simple Pay, Quick Pay, or the like) is received or when a predetermined application is executed. For example, the user may use the payment application 512 to perform a payment function, and may receive information related to the payment function.

According to various embodiments of the present disclosure, the payment application 512 may perform an operation of synchronizing the card or the card information stored in the user account in the payment server 520 in response to the payment transaction performed using the electronic device 800. The synchronizing operation may make, based on the user account, the type, the number, or the status of the card(s) or token(s) of the electronic device match that of the payment service server.

The payment manager 514 may include information related to the card company. For example, the payment manager 514 may include a software development kit (SDK) of the card company. In addition, the payment manager 514 may receive the status of the card or token information through the token server 605, a payment network 604, or a trusted service manager (TSM), and may change the same in the electronic device 800.

The payment server 520 may include a variety of management servers (e.g., a Samsung payment server) for electronic payment or mobile payment, such as a payment service server 522 and/or a token requester server 524.

According to various embodiments of the present disclosure, the payment server 520 may receive information related to payment from the electronic device 510, and may transmit the same to the outside or, may process the same therein. For example, the payment server 520 may transmit and receive information between the electronic device 510 and the token server 530 using the payment service server 522 and/or the token requester server 524.

The payment service server 522 may manage card information associated with a service account (e.g., Samsung account) or a user account. For example, the payment service server 522 may include an application program interface (API) server related to the payment application 512 or an account management circuit (e.g., account integration or Samsung account integration).

According to various embodiments of the present disclosure, the payment application 512 included in the electronic device 510 may be operatively connected to the payment service server 522 so that payment-related information may be transmitted to, and received from, the payment server 520 through the payment application 512.

The token requester server 524 may perform issuance, deletion, or activation of the payment-related information (e.g., a token). For example, the token requester server 524 may be operatively connected to the payment manager 514 in order to thereby control the information necessary for the payment.

According to various embodiments of the present disclosure, the payment manager 514 included in the electronic device 510 may be operatively connected to the token requester server 524 so that payment-related information may be transmitted to, and received from, the token requester server 524 through the payment manager 514.

The token server 530 may include a token management server for managing tokens, and may issue or manage payment data (e.g., a token). For example, the token server 530 may provide a variety of token-related functions such as setting, identification and verification (ID & V), replenishment, creation, modification, deletion, or control/management of life cycle of a token. In addition, the token server 530 may perform integration of information in relation to the financial server 540.

According to various embodiments of the present disclosure, the payment server 520 and/or the token server 530 may be located in the same or similar areas, or may be located in separate areas from each other. For example, the payment server 520 may be included in a first server, and the token server 530 may be included in a second server. In addition, the payment server 520 and/or the token server 530 may be separately implemented in one server (e.g., a first server or a second server).

The financial server 540 may include a device or a server in a card company or a bank, which issues cards, and may be operatively connected to the token server 530 to thus transmit and receive information necessary for the payment.

According to various embodiments of the present disclosure, the financial server 540 may generate information necessary for payment, which is provided to the user. For example, the information necessary for the payment, which is generated by the financial server 540, may be stored in the electronic device 510 through the payment application 512.

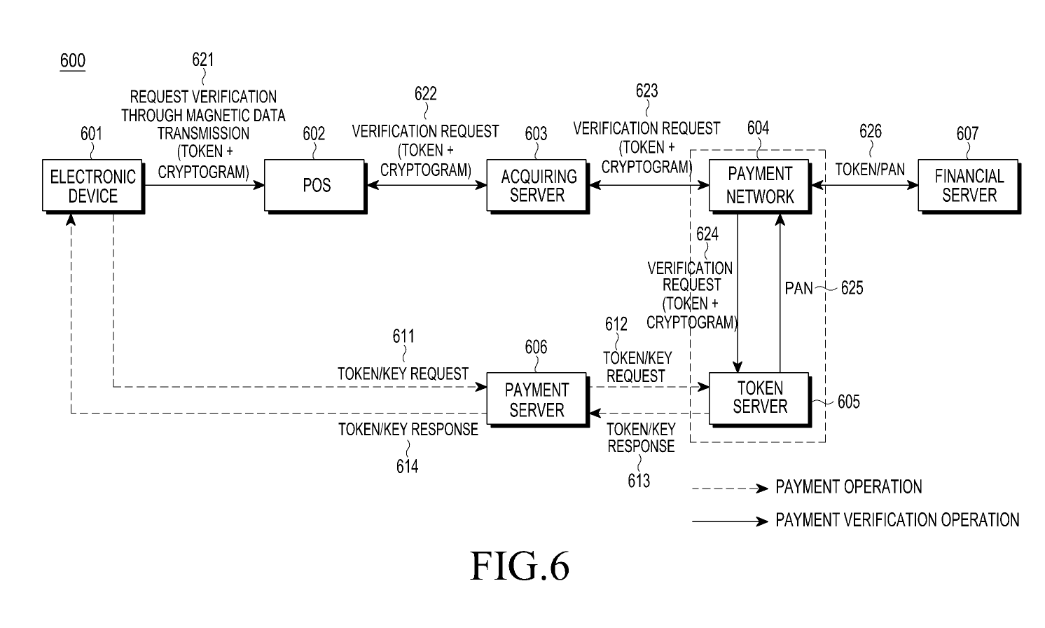

FIG. 6 is a view illustrating an example of issuing a token and performing payment using the issued token in a payment system, according to various embodiments of the present disclosure.

Referring to FIG. 6, the payment system 600 may include at least one of an electronic device 601, a POS 602, an acquiring server 603, a payment network 604, a token server 605, a payment server 606, and a financial server 607.

According to various embodiments of the present disclosure, the payment system 600 may issue a token, and may verify payment using the issued token.

In operation 611, the electronic device 601 may make a request to the payment server 606 for issuing a token or a key for decrypting the token.

In operation 612, the payment server 606 may transfer, to the token server 605, the token or key request of the above operation 611.

In operation 613, the token server 605 may confirm the transferred token or key request, and may transmit a response to the payment server 606. For example, the response to the token or key request may include information about at least one token generated for the electronic device 601 and key information of the generated token.

In operation 614, the payment server 606 may transmit, to the electronic device 601, the token or key response received from the token server 605. For example, the electronic device 601 may confirm the transmitted response, and may confirm and store the token or key information generated by the token server 605.

According to various embodiments of the present disclosure, the electronic device 601 may perform payment using the token.

In operation 621, when a payment request is received, the electronic device 601 may transmit a verification request to the POS 602 through magnetic data transmission. For example, the verification request may include at least one piece of token or cryptogram information.

In operation 622, the POS 602 may transmit, to the acquiring server 603, the verification request including at least one piece of the token or cryptogram information received from the electronic device 601.

In operation 623, the acquiring server 603 may transmit, to the payment network 604, the verification request including at least one piece of the token or cryptogram information received from the POS 602. The acquiring server 603 may be a server of an acquiring bank, a value added network (VAN) company, or a payment gateway (PG).

In operation 624, the payment network 604 may transmit, to the token server 605, at least one piece of the transmitted token or cryptogram information in order to thereby request card information (a PAN) corresponding to the transmitted token information.

In operation 625, the token server 605 may identify PAN information corresponding to at least one piece of the transmitted token or cryptogram information, and may transmit the same to the payment network 604. The token server 605 may store a key corresponding to a key (e.g., the key 442) generating the cryptogram, and may verify the validity of the transmitted cryptogram using the stored key. For example, the payment network 604 may include a device or a server of the card company.

According to various embodiments of the present disclosure, the payment network 604 may be operated by the same server as the token server 605. In this case, the operation 624 or 625 described above may be omitted or changed.

In operation 626, the payment network 604 may transmit, to the financial server 607, at least one piece of the token or cryptogram information and the PAN information corresponding to the token. For example, the financial server 607 may include a device or a server of a bank that issued the card requested for payment.

According to various embodiments of the present disclosure, the financial server 607 may determine whether or not the card requested for payment is valid based on at least one piece of the received token or cryptogram information or based on the PAN information, thereby determining whether or not the payment is to be approved. For example, the financial server 607 may complete the payment approval if the card is valid, and may determine that the payment approval has failed or has been held if the card is not valid.

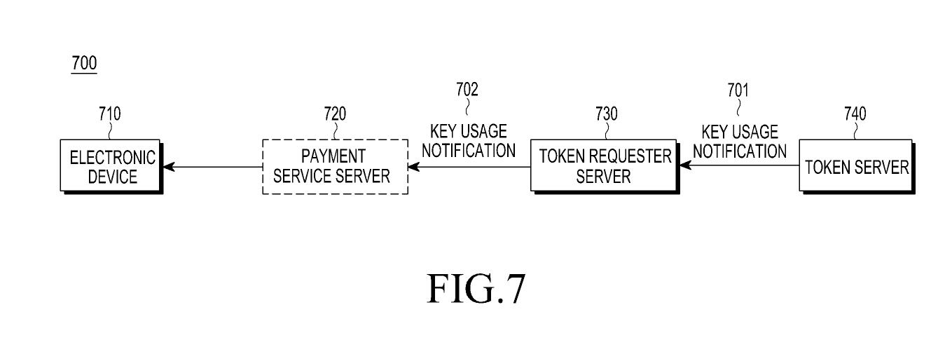

FIG. 7 is a flowchart illustrating an example of an operation of confirming the token usage in a payment system, according to various embodiments of the present disclosure.

Referring to FIG. 7, the payment system 700 may include at least one of an electronic device 710, a payment service server 720, a token requester server 730, or a token server 740.

In operation 701, the token server 740 (or the token server 605) may inform the token requester server 730 that the key used to generate the cryptogram has been used in the payment using the token.

According to various embodiments of the present disclosure, the token server 740 may confirm that the token or key corresponding to the card information has been used through the server (e.g., the financial server 607). For example, when the token and the PAN information are received, the server (e.g., the financial server 607) may perform payment, based on the corresponding PAN information, and the server may perform verification of the user or the token for payment.

In operation 702, the token requester server 730 may transfer the key usage notification received from the token server 740 to the payment service server 720.

According to various embodiments of the present disclosure, the payment service server 720 may be included in the token requester server 730, or may be implemented as a single server. In this case, the key usage notification may be transmitted from the token requester server 730 to the electronic device 710. For example, the payment service server 720, as a part of the payment server, may perform at least one operation performed by the payment server.

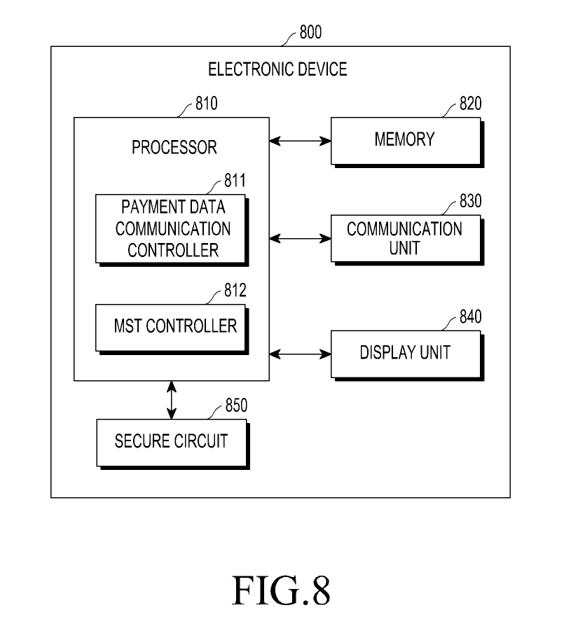

FIG. 8 is a block diagram illustrating an example of the configuration of an electronic device, according to various embodiments of the present disclosure.

Referring to FIG. 8, an electronic device 800 may include at least one of a processor 810, a memory 820, a communication unit 830, a display unit 840, or a secure circuit 850.

The processor 810 may include a payment data communication controller 811 or an MST controller 812. In addition, the processor 810 may include a variety of configurations to perform payment using the token and to identify information related to a key used in the payment.

The payment data communication controller 811 may transmit payment data to the outside in response to a payment request received through the electronic device 800. For example, the payment data may include card information for payment or verification information (e.g., at least one of a token, a key, or a cryptogram) corresponding to the card information.

According to various embodiments of the present disclosure, the payment data communication controller 811 may transmit magnetic data corresponding to the payment data through the MST controller 812. In addition, the payment data communication controller 811 may be a module interworking with at least one of the payment application 512 or the payment manager 514, or may be configured as a single module.

The MST controller 812 may generate magnetic data corresponding to the payment data, and may transmit the same to an external device (e.g., the payment device). For example, the magnetic data may include an electromagnetic-field signal that can be read by the MST reader of the payment device.

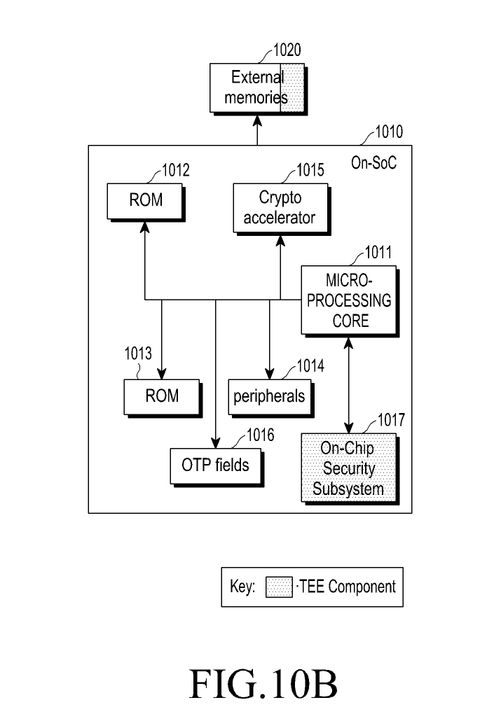

The memory 820 may store information on at least one card or verification information corresponding to the card information, and may store a variety of other information related to the payment as well. The memory 820, based on a trusted execution environment (TEE), may encrypt and store the card information or verification information corresponding to at least one piece of card information. The TEE will be described later with reference to FIG. 11.

According to various embodiments of the present disclosure, the verification information may be issued by, and received from, a server (e.g., the token server, the token requester server, or the payment server).

The communication unit 830 may transmit or receive the verification information corresponding to the card information to or from an external device (e.g., a server).

The display unit 840 may output a notification related to payment. For example, the notification may include a notification related to payment approval information, information on whether or not the verification information used for payment has been used, or user card information, and may include a variety of notification information that can be output in relation to payment as well. The display unit 840 may be omitted depending on an electronic device. For example, the display unit 840 may be excluded in the case of an electronic device in the form of an accessory.

The secure circuit 850 may be a secure element (SE). The SE may include at least one of an embedded universal integrated circuit card (eUICC), an embedded secure element (eSE), or micro secure digital (micro-SD). The secure circuit 850 may be configured to store at least one piece of card information or verification information corresponding to the at least one piece of card information.

An electronic device, according to various embodiments of the present disclosure, may include: at least one communication circuit; a memory configured to store verification information; and a processor configured to perform control so as to transmit, to a payment device, payment data, which is generated using the verification information, through a first communication circuit in response to a payment request input through the electronic device, configured to check whether or not a payment response message including information related to payment execution using the payment data is received through a second communication circuit, and configured to manage the stored verification information depending on whether or not the payment response message is received within a predetermined time.

The verification information, according to various embodiments of the present disclosure, may include key information for decrypting a cryptogram included in the payment data.

The information related to the payment execution, according to various embodiments of the present disclosure, may include information indicating whether or not the first verification information has been used for the payment request.

The first communication circuit, according to various embodiments of the present disclosure, may be configured to transmit the payment data in a magnetic stripe transmission (MST) manner.

The payment response message, according to various embodiments of the present disclosure, may include at least one piece of verification information used for payment, newly issued verification information, payment amount information, or payment execution result information.

The processor, according to various embodiments of the present disclosure, if the payment response message is received within a predetermined time, may confirm whether or not the payment using the payment data has been performed by checking the received payment response message, and, if it is confirmed that the payment using the payment data has been performed, may perform control so as to delete the first verification information from the stored verification information.

The processor, according to various embodiments of the present disclosure, may identify the number of pieces of the stored verification information to thus make a request to a server for issuing new verification information through the second communication circuit, may receive newly issued verification information through the second communication circuit in response to the request for new verification information, and may store at least one piece of the received verification information in the memory to thus manage the stored verification information.

The processor, according to various embodiments of the present disclosure, may perform control so as to transmit identification information of the electronic device through the second communication circuit for communication with the server, and the identification information of the electronic device may include at least one of a telephone number, an internet protocol (IP) address, or a media access control (MAC) address of the electronic device.

The processor, according to various embodiments of the present disclosure, may perform control so as to perform communication with the server through a secure channel.

The processor, according to various embodiments of the present disclosure, may manage the stored verification information such that the first verification information is not to be deleted if the payment response message is not received within a predetermined time.

The processor, according to various embodiments of the present disclosure, may perform control so as to generate second payment data using the first verification information when second payment is requested, and so as to transmit the generated second payment data to the payment device through the first payment circuit.

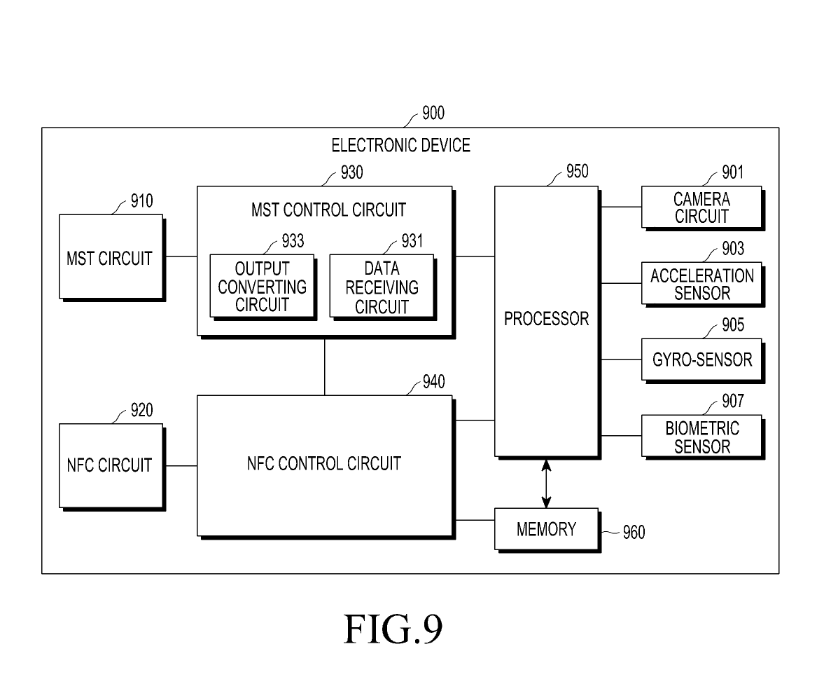

FIG. 9 is a block diagram illustrating an example of the configuration of an electronic device, according to various embodiments of the present disclosure.

Referring to FIG. 9, an electronic device 900 may include at least one of an MST circuit 910, an NFC circuit 920, an MST control circuit 930, an NFC control circuit 940, a processor 950, or a memory 960.

The MST circuit 910 may be configured to control an operation of transmitting magnetic data.

The MST control circuit 930 may include a data receiving circuit 931 and an output converting circuit 933.

According to various embodiments of the present disclosure, the electronic device 900 may transmit payment data to a POS device using at least one of the MST circuit 910 or the NFC circuit 920. The electronic device may transmit payment data to the POS using both the MST circuit 910 and the NFC circuit 920 in order to increase recognition rate. Alternatively, the electronic device may transmit payment data using the MST circuit 910, and if the payment fails, the electronic device may transmit the payment data using the NFC circuit 920. Furthermore, one of the MST circuit 910 or the NFC circuit 920 may perform payment for a specified period of time, and the other thereof may perform payment after the specific period of time.

The data receiving circuit 931 may be configured to receive a logical low/high pulse signal including payment data, which is transmitted by the processor 950 or a secure circuit {e.g., an embedded secure element (eSE)}.

The output converting circuit 933 may include a circuit for converting the data recognized by the data receiving circuit 931 into a format necessary for transmitting the same to the MST circuit 910. The circuit may include an H-bridge circuit for controlling the direction of a voltage supplied to both ends of the MST circuit 910. For example, the H-bridge circuit may include a circuit structure in which four switches are connected in an H-shape.

According to various embodiments of the present disclosure, although the MST circuit 910 and the MST control circuit 930 are illustrated as being separate elements, the MST circuit 910 may include at least some elements of the MST control circuit 930, and the MST circuit 910 may be configured to perform the functions of the MST control circuit 930.

The processor 950 may perform operations related to the electronic device 900. For example, the processor may perform payment, based on information received through at least one element (e.g., a camera circuit 901, an acceleration sensor 903, a gyro-sensor 905, or a biometric sensor 907).

The camera circuit 901 may be configured to obtain card information by photographing a payment card. For example, the camera circuit 901 may be configured to recognize card information (e.g., a card company, a card number, a card valid period, a cardholder, etc.) indicated by the card through an optical character reader (OCR) function.

According to various embodiments of the present disclosure, the user may input necessary card information into the electronic device 900 using an input device (e.g., a touch panel, a pen sensor, keys, an ultrasonic input device, or a microphone input device) provided in the electronic device 900.

According to various embodiments of the present disclosure, based on card information input through the camera circuit 901 or the input device (e.g., a touch panel, a pen sensor, or the like), the processor 950 may perform control so as to receive payment data (e.g., track1/2/3 or token information) contained in a magnetic stripe of a magnetic card from a server of a card company or a bank through a communication circuit (not shown) and so as to store the same in a memory 960 or a separate secure circuit 960 (e.g., the eSE) (not shown).

The acceleration sensor 903 or the gyro-sensor 905 may obtain the locational status of the electronic device 900 at the time of payment. For example, the processor 950 may identify the obtained locational information of the electronic device 900, and may perform control so as to store the identified locational information in the memory 960.

The biometric sensor 907 may obtain biometric information of the user. For example, the processor 950 may perform control so as to store the obtained biometric information (e.g., iris, skin, pulse, or fingerprint information) in the memory 960 or a separate secure circuit (e.g., the eSE) (not shown).

The memory 960 may store information related to payment. For example, the payment-related information may include card information input through an input device (e.g., a camera module circuit 901, a touch panel, a pen sensor, or the like), locational information of the electronic device 900 at the time of payment, which is obtained through a location sensor (e.g., the acceleration sensor 903 or the gyro-sensor 905), or biometric information of the user obtained through the biometric sensor 907.

According to various embodiments of the present disclosure, based on locational information of the electronic device 900, which is obtained through at least one sensor (e.g., the acceleration sensor 903 or the gyro-sensor 905), the processor 950 may adjust the intensity of the magnetic field (the intensity of current) transmitted from the MST circuit 910 to the payment device (e.g., the POS), or may select at least one coil antenna to be used from among a plurality of coil antennas.

According to various embodiments of the present disclosure, the processor 950, based on the biometric information of the user obtained through at least one sensor (e.g., the biometric sensor 907), may transmit payment data. For example, if the obtained biometric information of the user matches the user information stored in the electronic device 900, the processor may transmit payment data to the payment device (e.g., the POS) in response to a payment request of the user.

According to various embodiments of the present disclosure, the processor 950 may be the same processor as the processor 810.

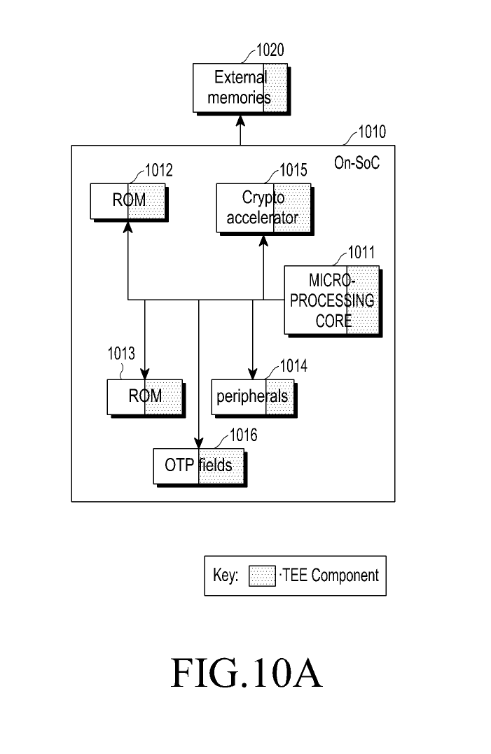

FIGS. 10A to 10C are block diagrams illustrating various examples of a TEE structure, according to various embodiments of the present disclosure.

According to various embodiments of the present disclosure, the hardware structure of the TEE may include an On-SoC 1010 and external memories 1020. For example, the On-SoC 1010 may include a micro-processing core 1011, a ROM 1012, a RAM 1013, peripherals 1114, a crypto accelerator 1015, or OTP fields 1016. A trust zone may divide a processor, in time, into an REE and a TEE for usage in order to operate two or more execution environments. In addition, the trust zone may divide one memory into an area accessible by the REE and an area accessible by the TEE (a TEE component) for usage.

Referring to FIG. 10A, one processor and one memory may be divided into an REE and a TEE for usage (e.g., a trust zone (TZ) of ARM) in terms of hardware.

Referring to FIG. 10B, although a processor for the TEE is implemented on a chip together with a processor for operating the REE, it may be implemented as a separate processing core set.

According to various embodiments of the present disclosure, the On-SoC 1010 may further include an on-chip security subsystem 1017 including one or more processors in addition to the micro-processing core 1011. For example, the On-SoC 1010 may be configured to operate the REE and the on-chip security subsystem 1017 may be configured to operate the TEE.

According to various embodiments of the present disclosure, one memory in FIG. 10B may be divided into an area accessible by the REE and an area accessible by the TEE for usage as the case of FIG. 10A.

Referring to FIG. 10C, the processor for the TEE may be implemented as a separate chip in hardware, and may be separated from the processor for operating the REE. For example, the On-Soc 1010 may be configured to operate the REE, and the TEE may be operated through one or more external security co-processors 1030 provided outside the On-Soc 1010.

FIG. 11 is a block diagram illustrating an example of circuits that can be executed in an execution environment of an electronic device capable of performing a payment function, according to various embodiments of the present disclosure.

Referring to FIG. 11, an execution environment 1101 may include a rich execution environment (REE) 1110 and a trusted execution environment (TEE) 1120.

According to various embodiments of the present disclosure, the electronic device may operate the execution environment 1101 having a plurality of security levels for security enhancement. For example, the REE 1110 may be a first execution environment having a first security level. The TEE 1120 may be a second execution environment having a second security level different from (for example, higher than) the first security level.

According to various embodiments of the present disclosure, the electronic device (e.g., the wearable device 111) may include an additional execution environment (e.g., a third execution environment) having a third security level, but is not limited thereto.

The REE 1110 may include a payment application 1130, a payment manager 1140, or a kernel 1150.

The payment application 1130 may include a payment management circuit 1131, a server interworking circuit 1133, a verification circuit 1135, and a peripheral device management circuit 1137.

The payment management circuit 1131 may be configured to perform operations for card registration, card verification, card deletion, and payment. For example, the payment management circuit 1131 may be configured to register the user's card when the electronic device (e.g., the electronic device 111) receives a request for card registration from the user, and when the user requests deletion of at least one of pre-registered cards, may be configured to delete information corresponding to the corresponding card from the memory or to make a request to the payment server for deleting the same.

According to various embodiments of the present disclosure, the payment management circuit 1131 may check whether or not the owner of the card matches the user who registers the card. The payment management circuit 1131 may include an ID & V circuit. The payment management circuit 1131 may be configured to perform user verification through text, e-mail, an ARS, or a telephone call. In addition, the payment management circuit may be configured to perform verification through an application issued by a card company or a bank. The card registered through the payment management circuit 1131 may be used after verification.

According to various embodiments of the present disclosure, the payment management circuit 1131 may be configured to obtain a card image through an optical character reader/recognition (OCR) circuit or a camera circuit of the electronic device, or may be configured to obtain user-related information (e.g., a password, a home address, an email address, a phone number, or an account ID) by means of a user input or from a server (e.g., the payment server 720).

According to various embodiments of the present disclosure, the payment management circuit 1131 may include the OCR circuit. For example, the OCR circuit may be configured to obtain characters, images, or numbers, which are written by humans or printed by machines, from the card image using a scanner and to convert the same into machine-readable characters. The OCR circuit may be configured to obtain the user card information (e.g., a card number, a user name, or a valid period) through the converted characters. The OCR circuit may be configured to obtain the user card information and to perform a card registration process. For example, information on a first card (e.g., a Visa card) and a second card (e.g., a master card), which is generated through the OCR circuit, may be registered in an account created when joining a Samsung account (e.g., registration02@samsung.com). Based on the created account, the registered information may be synchronized with the payment server.

According to various embodiments of the present disclosure, membership information generated through a barcode interface may be included in a first card (e.g., a Samsung points card) and a second card (e.g., a CJ membership points card), based on the account created when joining a Samsung account (e.g., registration01@samsung.com). Based on the created account, the registered information may be synchronized with the payment server.

According to various embodiments of the present disclosure, the payment management circuit 1131 may be electrically connected to an account management circuit (not shown), and the account management circuit may be configured to manage card information (e.g., Visa card ID & V) and membership information (e.g., CJ membership points, registraion001@Cj.com, or the like), which are associated with a service account (e.g., registration01@samsung.com) while interworking with the payment server. For example, the membership information may be automatically accumulated or deducted through an interworking process between payment processing information (e.g., a payment amount) and membership accumulation information (e.g., point scores, mileages, or the like) at the time of card payment.

According to various embodiments of the present disclosure, the payment management circuit 1131 may be configured to output (e.g., display) information on the registered card through a display of the electronic device. The user may correct at least some of the registered card information (e.g., a card name, a home address, a telephone number, the number of attempts to make a payment, the reception of payment notification information, or the like). For example, the payment management circuit 1131 may be configured to display transaction details for each card or to display card information registered in a wearable device (e.g., a smart watch) that is operatively connected to the electronic device.

According to various embodiments of the present disclosure, the payment management circuit 1131 may be configured to perform a payment operation using the registered card. For example, the payment management circuit 1131 may allow the verification circuit 1135 to perform user verification (e.g., fingerprint verification) for the payment operation. When the user selects one of a plurality of cards registered for payment and places the electronic device close to the POS device, the payment management circuit 1131 may display a service or product information (e.g., price) received from the POS device. When the verification is completed, the payment management circuit 1131 may output (e.g., display) notification information stating that the payment has been completed.

According to various embodiments of the present disclosure, the payment management circuit 1131 may be configured to output (e.g., display) a barcode created for payment. For example, the payment management circuit 1131 may be configured to receive, from the POS, a command for creating a barcode for making payment through the barcode reader. The payment management circuit 1131 may be configured to create, based on the command, a barcode.

The server interworking circuit 1133 may be configured to receive, from the payment server or the token service provider, messages related to the payment, the electronic device, or the service. For example, the server interworking circuit 1133 may be configured to transfer the messages to the payment management circuit 1131.

According to various embodiments of the present disclosure, the server interworking circuit 1133 may include a push management circuit and an account management circuit. For example, if the message received from the payment server is a push notification in relation to a token, the push management circuit may process the received message, and if the received message includes information related to an account (e.g., a Samsung account), the account management circuit may process the received message.

According to various embodiments of the present disclosure, the push management circuit may be configured to calculate and handle push notification information or push message information received from the payment server. The push message may be transmitted to the server interworking circuit 1133 inside the payment application 1130 through a payment relay circuit 1141 inside the payment manager 1140, or may be directly transmitted to the payment application 1130. At least some of the transmitted push messages may be transmitted to the payment management circuit 1131, thereby updating the card-related information and being synchronized with the payment server.

According to various embodiments of the present disclosure, the message information received by the push management circuit may include token and payment-related information such as provisioning (e.g., token provisioning), suspension (e.g., token suspension), resumption (e.g., token resumption), disposal (e.g., token disposal), status change (e.g., token status change), additional issuance (e.g., token replenishment), payment confirmation (e.g., transaction notification), and the like. For example, if the token provisioning ID & V information obtained in the payment management circuit 1131 is successfully transferred to the external server and the transferred token-related information is valid, the server interworking circuit 1133 may receive a “push token {id} status changed” message to then transmit the same to the payment management circuit 1131.

According to various embodiments of the present disclosure, card information suspension (e.g., token suspension) information obtained in the payment management circuit 1131 of the electronic device may enable to transmit a suspension command of the payment server (e.g., the payment service server 720) to the payment application 1130 in order to thereby switch the card setting status for mobile payment from activation to inactivation.

According to various embodiments of the present disclosure, the messages transmitted/received by the account management circuit may include at least some of electronic device-related information such as a lost-electronic device identification function (e.g., a lost device, find my mobile, or the like), remote blocking (e.g., remote lock/unlock), membership management (e.g., loyalty/membership cards), a web interworking function (e.g., website portal-online), or the like.

According to various embodiments of the present disclosure, the payment server may be configured to delete or suspend all of the token information stored therein when the electronic device is lost. For example, the payment server may be configured to transmit a push message to the payment application 1130 through the payment relay circuit 1131 or the server interworking circuit 1133 (e.g., the push management circuit or the account management circuit) in order to synchronize the deleted or suspended token information with the payment application 1130.

According to various embodiments of the present disclosure, the account management circuit may be configured to allow the payment application to manage information such as a user identifier (e.g., a Samsung account ID or a device ID) transmitted to/received from the payment server (e.g., the payment service server 720), a card, or a membership. The user identifier may include an account that the user has registered in order to manage cards of a plurality of companies (e.g., a Visa card or a Master card), a portal account related to the electronic device, or an identifier of the electronic device {e.g., a model name, a media access control (MAC) address, IMEI, a serial number, UUID, ID, or the like}. In addition, the identifier may be a value that is generated by and transmitted from the payment server (e.g., the payment service server 720) through the account.

According to various embodiments of the present disclosure, the account management circuit may be configured to manage registration, addition, deletion, duplicate registration, suspension, or resumption of a card using the user account or the identifier of the electronic device. In addition, the account management circuit may be configured to manage, based on an account created in the case where the card information is imported/exported between the electronic device and the wearable device or the identifier of the electronic device, registration, addition, deletion, confirmation of duplicate registration, suspension, or resumption of a card. According to the account-based management method, a plurality of electronic devices or a plurality of users sharing one account may be managed so that a unique account (e.g., a Samsung account) can be used for each electronic device or a plurality of electronic devices can be integrally managed using one account.

According to various embodiments of the present disclosure, the user may determine the active/inactive status of the card, based on the account after login-in through the payment application 1130, and may transfer the same to the payment server (e.g., the payment service server 710) using the account management circuit 1131, or may convert the account-based card status in a server management web page (e.g., a server portal). For example, when the payment application 1130 including the account management circuit is installed, the setting status of some or all of the existing registered cards may be associated by means of a log-in (or sign-in) process for the user account in various electronic devices, and membership information having a relatively low verification security level may be registered or associated through the user account, thereby simplifying an additional verification process.

The verification circuit 1135 may be configured to output (for example, display) a UI for performing verification for a card or user for payment. For example, the verification circuit 1135 may include, or may be electrically connected to, the biometric information circuit 1125, and may be configured to obtain a user's biometric information through the biometric information circuit. The user's biometric information may include fingerprint information, iris information, face image information, voice information, heartbeat information, or blood pressure information.

According to various embodiments of the present disclosure, a user's fingerprint and a card for payment may be specified in the electronic device. For example, when the user performs verification using a fingerprint (e.g. a fingerprint of a right hand thumb or index finger) in the payment application 1130, the user may make payment using the card specified for the corresponding fingerprint.

The peripheral device management circuit 1137 may manage external devices operatively connected to the electronic device. For example, the peripheral device management circuit 1137 may include a circuit of a peripheral device including an MST circuit or a wearable device, or may be electrically connected thereto.

According to various embodiments of the present disclosure, the peripheral device including an MST circuit may output the status of a wired/wireless connection between an MST accessory (e.g., a ring-type device) and the electronic device, and may provide, based on the output, a UI. For example, the UI may include an interface for processing and outputting processes of card registration, deletion, and payment while the MST accessory is connected.

According to various embodiments of the present disclosure, the peripheral device including an MST circuit may store a variety of card information necessary for payment in the electronic device or a separate memory in the MST accessory while being connected with the MST accessory so that the electronic device or the MST accessory may perform payment independently even when it is disconnected from the MST accessory.

The wearable device circuit may be configured to output the wired/wireless connection status between a wearable device (e.g., a watch, a headset, glasses, or a ring) and the electronic device, and may provide, based on the same, the user with a proper UI. The wired/wireless connection may include various interfaces, such as BT, BLE, Wi-Fi, Zigbee, or Z-wave, and may be implemented by applying a specific accessory protocol {e.g., a Samsung accessory protocol (SAP)}. The UI may perform processes of card registration, card deletion, and card payment while the wearable device is connected, and may output the same. The wearable device circuit may be configured to output whether or not to establish a short-range-based secure session with a wearable device, and may be configured to transmit/receive user input values on the electronic device or the wearable device to thus display the same in the process of card registration, card deletion, or card payment. The user input may include a variety of card information required for payment and other additional verification information (e.g. PIN, user specific pattern-related data, fingerprint recognition-related data, a touch input value onto a bezel part or a display in the wearable device, or the like).

The payment manager 1140 may include a payment relay circuit 1141, a biometric information management circuit 1143, or a secure environment relay circuit 1146.

The payment relay circuit 1141 may be configured to relay a card or verification information (e.g., a token) corresponding to the card to the payment application 1130, the kernel 1150, or the payment server. For example, the payment relay circuit 1141 may be configured to perform online payment through a first communication circuit (e.g., a cellular circuit, an RF circuit, a Wi-Fi circuit, or the like), or may be configured to perform offline payment through a second communication circuit (e.g., an NFC circuit, an MST circuit, or the like). The payment method using the NFC may be operated through the POS, and the payment method using the MST may be operated by a user input.

According to various embodiments of the present disclosure, the payment relay circuit 1141 may be configured to manage the status of a card or information (e.g., a token) corresponding to the card (for example, managing a card/token life-cycle). For example, the payment relay circuit 1141 may be configured to transmit at least one API in relation to the payment to the payment application 1130.

According to various embodiments of the present disclosure, the payment relay circuit 1141 may further include interfaces, which are provided by one or more system services related to payment (i.e., system service interfaces), for providing a payment service to access a payment circuit, a trust zone-based integrity measurement architecture (TIMA) for kernel integrity verification, an enquiry about fingerprint recognition results (for example, supporting both security and non-security modes), and a secure UI for inputting a PIN or PAN. For example, the payment relay circuit 1141 may be configured to transmit and receive messages or commands to and from the TEE 1120 through an encryption library. The payment relay circuit 1141 may be configured to exchange messages or instructions with the secure environment relay circuit 1146 through the encryption library.

According to various embodiments of the present disclosure, the payment relay circuit 1141 may be configured to perform general card management functions such as card addition, card deletion, card renewal, or the like.

According to various embodiments of the present disclosure, the payment relay circuit 1141 may include a first payment software development kit (SDK) or a second payment SDK, and may further include various SDKs provided through a payment network. The SDK may include token management, POS device-related message processing, or a token/card database. The first payment SDK (e.g. a Samsung SDK) may be embedded in the electronic device by a manufacturer and the second payment SDK may be installed in the electronic device through a card company or a bank.

According to various embodiments of the present disclosure, the payment relay circuit 1141 may be configured to select a payment SDK, depending on card information, from among the first payment SDK or the second payment SDK or to select a predetermined default card. The payment relay circuit may also be configured to select various other cards.

According to various embodiments of the present disclosure, the payment relay circuit 1141 may be configured to transmit, to the payment server, messages, such as provisioning, additional issuance, suspension, resumption, disposal, or the like, for general token and key management functions.

According to various embodiments of the present disclosure, the content of the push API supported by the electronic device and the payment relay circuit 1141 may include a push platform (e.g., device.push), a Samsung push ID (e.g., device.push.spp.id), or a Google push ID (e.g., device.push.gcm.id).

According to various embodiments of the present disclosure, the payment relay circuit 1141 may be configured to receive a push message from the token service provider and to transfer the same to the payment application 1130.

According to various embodiments of the present disclosure, the payment relay circuit 1141 may be configured to relay a received request for a token management function to the second payment SDK in the case where the first payment SDK (provided by a card company or a bank) provides its own token management function. For example, when a token or key is obtained through the SDK of the first card (e.g., a Visa card), the payment relay circuit 1141 may be configured to transmit a request for a token management function to the payment circuit 1121 in the TEE 1120 through the SDK of the second card (e.g., a Samsung card).

According to various embodiments of the present disclosure, the payment relay circuit 1141 may further include a host card emulation (HCE) function on the payment framework, which enables a virtual card to be used in the electronic device only by means of software without a separate hardware device {e.g., a secure circuit or a secure element (SE)} for payment. The HCE function may transmit a token and a token cryptogram using the message standard related to the POS {e.g., an application protocol data unit (APDU)} through a communications circuit (e.g., the NFC circuit).

According to various embodiments of the present disclosure, the payment relay circuit 1141 may be configured to process messages received from the POS device, and may be configured to manage the payment data received from the POS device. For example, a function of interpreting the POS device-related message may relay the POS device-related message to the first payment SDK in the case where the first payment SDK processes the POS device-related message by itself.

According to various embodiments of the present disclosure, the payment relay circuit 1141 may include at least one database for storing card information, token data, transaction data, and the like.

According to various embodiments of the present disclosure, the payment relay circuit 1141 may be configured to select a communication circuit {e.g., the first communication circuit (NFC) or the second communication circuit (MST)} for payment. For example, the payment relay circuit 1141 may be configured to determine a communication circuit for performing payment first among the first communication circuit or the second communication circuit, or may be configured to perform payment using both a first communication method and a second communication method. For example, in the case where the payment is performed by one communication circuit and is then performed by the other communication circuit, if there is no response to the execution result of the payment previously performed by the one communication circuit, or if a predetermined time expires, the payment relay circuit 1141 may perform payment by means of the other communication circuit.

According to various embodiments of the present disclosure, in the case where the payment relay circuit 1141 has both the token information and the PAN information for a card, the payment relay circuit 1141 may be configured to perform payment using at least one of them. For example, the payment relay circuit 1141 may be configured to check whether the POS device can perform payment by means of either the PAN or the token and to perform, based on the checked information, payment. For example, the payment relay circuit 1141 may be configured to receive payable information from the electronic device through short-range communications (e.g., BLE).

According to various embodiments of the present disclosure, the payment relay circuit 1141 may be configured to perform a function of relaying a verification request through a PIN input of the payment application 1130 to a secure identifier processing circuit 1123 of the TEE 1120. For example, a general application may obtain success or failure with respect to a fingerprint recognition request, and a trusted payment application may obtain a secure biometric result (e.g., secure fingerprint result). The secure biometric result may be configured in an encrypted form by combining a one-time random number (e.g., the nonce or a random number) and the success/failure result. The one-time random number may be encrypted by means of a hardware key {e.g., a device root key (DRK)} of the TEE 1120.

According to various embodiments of the present disclosure, the payment relay circuit 1141 may be configured to transmit, through a secure environment driver circuit 1153, a message instructing the payment circuit 1121 to perform payment.

According to various embodiments of the present disclosure, the payment relay circuit 1141 may be configured to transmit, through a biometric information management circuit 1143 and a biometric information driver circuit 1151, a message instructing the biometric sensor 2401 to obtain biometric information for the verification operation, and may be configured to transmit a verification confirmation message to a biometric information circuit 1125 of the TEE 1120 through the biometric information management circuit 1143 and the secure environment driver circuit 1153.

According to various embodiments of the present disclosure, the payment relay circuit 1141 may be configured to perform verification by means of an external device. For example, the electronic device may make a request to the payment server (e.g., a Samsung account server or a token requester server) for verification of biometric information (e.g., a fingerprint or an iris). The payment server may perform verification for a user's biometric information, and may transfer a result thereof to the electronic device.

According to various embodiments of the present disclosure, when the verification of the user's biometric information is completed, the payment relay circuit 1141 may be configured to notify the token service provider of the completion of verification, and thus a token may be provided. For example, the electronic device may perform payment if the verification is completed, and may not perform payment if the verification has not been completed or has failed.

Various embodiments of the present disclosure may further include a secure environment relay circuit 1146 in the payment manager 1140, which enables the payment application to use the functions of the secure identifier processing circuit of the TEE.

The secure environment relay circuit 1146 may be configured to perform a relay function of allowing the payment application 1130 to access the biometric information driver circuit 1151 or the secure environment driver circuit 1153 in order to use functions provided by the payment circuit 1121 or the biometric information circuit 1125.

The kernel 1150 may include the biometric information driver circuit 1151 and the secure environment driver circuit 1153.

The biometric information driver circuit 1151 may be configured to transmit, to the biometric sensor, a message received from the biometric information management circuit 1143 of the payment manager 1140. The biometric information obtained by the biometric sensor may be transmitted to the biometric information circuit 1125 in the TEE 1120, instead of being transmitted to the circuit in the REE 1110, through the biometric information driver circuit 1121.

The secure environment driver circuit 1153 may act as an interface between the circuit in the REE 1110 and the circuit in the TEE 1120. For example, in the case of a trust zone of the ARM, which is an embodiment of the TEE, the application processor may perform REE and TEE operations on a time-division basis. In this case, a separate data path for transmitting a message from the REE to the TEE may be implemented in hardware. That is, the driver circuit for accessing the hardware may include the secure environment driver circuit 1153. The secure environment driver circuit 1153 may be configured to transfer a message for the operation of a circuit in the TEE to a circuit in the REE.

The TEE 1120 may include the payment circuit 1121, the secure identifier processing circuit 1123, the biometric information circuit 1125, and the MST driver circuit 1127.

According to various embodiments of the present disclosure, the TEE 1120 may store data requiring a relatively high security level in a secure environment, and may perform operations related thereto. For example, the TEE 1120 may operate on an application processor of the electronic device, or may operate based on a reliable hardware structure determined in the manufacturing process of the electronic device. The TEE 1120 may divide an application processor or a memory into a general area and a secure area, and may then operate in the secure area. The TEE 1120 may allow software or hardware requiring security to operate only in the secure area. The electronic device may operate the TEE 1120 through a physical change in the hardware or a logical change in the software.

According to various embodiments of the present disclosure, the TEE 1120 may be separated from the REE 1110 by means of hardware constraints, and may operate in the same hardware while being separated in software. At least one application (e.g., a payment, contact, e-mail, or browser application) executed in the REE 1110 may use an API (e.g., a TEE-functional API or a TEE-client API) that is allowed to access the TEE 1120. The at least one application may transmit a message from a communication agent of the REE 1110 (REE communication agent) to a communication agent of the TEE 1120 (TEE communication agent) using the API. The message may be implemented to be transmitted only to the TEE 1120 in hardware. The communication agent of the TEE 1120 may receive the message, and may transfer the same to a trusted application (TA) (e.g., DRM, a secure payment circuit, or a secure biometric information circuit) that is related to the message. The trusted application may perform operations related to the message, and may transmit the results of the operations to the communication agent of the REE 1110 through the communication agent of the TEE 1120. The communication agent of the REE 1110 may transfer the results to at least one application operating in the REE 1110.

According to various embodiments of the present disclosure, the TEE 1120 may check the integrity of the REE 1110 to thus store a result thereof. When a boot loader is executed, the TEE 1120 may be booted and then the REE 1110 supporting the TEE 1120 may be booted. Once the TEE is booted, integrity information of the REE in the TEE may be checked to be thus displayed to the user after booting the REE. According to an embodiment, if an image of the REE is corrupted by hacking, routing, or the like, it may be determined that there is a problem with the integrity. If there is a problem with the integrity, the access to the TEE may not be allowed. For example, when the payment relay circuit 1141 attempts to transmit a message or an instruction to the TEE through the secure environment driver circuit 1153, the kernel of the TEE may ignore or reject the message or instruction.

According to various embodiments of the present disclosure, an application (e.g., the trusted application, the payment circuit, or the like) in the TEE 1120 may transmit messages to an external electronic device (e.g., the token service provider).

According to various embodiments of the present disclosure, the TEE 1120 may include a trusted OS, a trusted application, an encryption circuit in relation to security, or a driver for collecting data from the hardware requiring security. The trusted application may include the payment circuit 1121, and may transmit payment data to the outside through a communication circuit. For example, the trusted application may transfer the payment data to the MST controller through the MST driver circuit 1127 or to the NFC controller through the NFC driver to thus transmit the same to the POS device.

The payment circuit 1121 may be configured to inform, through the secure environment driver circuit 1153, the payment relay circuit 1141 that a verification operation is required.

According to various embodiments of the present disclosure, the payment circuit 1121 may be configured to obtain tokens and token cryptograms from the electronic device or other external electronic devices. A key to create the token and the token cryptogram {e.g., a limited used key (LUK) or a single used key} may be stored in the REE 1110 or the TEE 1120. In addition, in the case where the token and the key are stored in the REE 1110, the payment circuit of the TEE 1120 may encrypt and store the same using the key of the TEE 1120 {e.g., a device root key (DRK)}.

According to various embodiments of the present disclosure, when the payment is performed through the electronic device, the payment relay circuit 1141 may be configured to obtain a token decrypted from the encrypted token through the payment circuit 1121. In the case where a key or token for creating the token cryptogram is stored in the TEE 1120, the electronic device may store the same in an encrypted form using the key of the TEE 1120.

According to various embodiments of the present disclosure, the payment circuit 1121 may be configured to include at least one application installed through a bank, a card company (e.g., Visa or MasterCard), or the like. For example, when a user of the electronic device accesses the payment server (e.g., a mobile application platform, a payment gateway, a token requester, a token service provider, a trusted service manager, a bank server, or the like) or the token service provider through the Internet using the payment management circuit 1131 and requests installation of the payment circuit 1121, the token service provider may perform operations related to the installation.

According to various embodiments of the present disclosure, by obtaining a card number and valid period information of a plastic card from the payment management circuit 1131 through the OCR, the token service provider may perform a card registration operation for installing the payment circuit 1121. An installation file may be received by accessing the token service provider in the network through the payment relay circuit 1141 having connection information of the respective token service providers depending on card companies/banks, and the payment relay circuit 1141 may transmit the above information to the TEE 1120 in order to thereby include the payment circuit 1121. The above operation may include a providing operation or a card registration operation.

According to various embodiments of the present disclosure, the payment circuit 1121 may include a plurality of circuits, and the respective payment circuits may be configured to be isolated to not exchange data with each other in the TEE 1120.

According to various embodiments of the present disclosure, the payment circuit 1121 may be configured to include an application to be used for data communication with the payment server or card information (e.g., information such as a credit card, a debit card, a membership card, or the like). For example, the payment circuit 1121 may be configured to communicate with another external electronic device using encrypted data. The encrypted data may be variously configured according to the card company providing the payment circuit 1121. The payment server may control the status of the payment circuit 1121 (e.g., activation, suspension, resumption, or disposal).

According to various embodiments of the present disclosure, the payment circuit 1121 may be configured to store information related to the card information and to generate information (e.g., a token) used for payment based on at least one piece of the information related to the card information. For example, the payment circuit 1121 may include at least one of a token corresponding to the card information (e.g., the PAN), a token reference ID, a portion of the PAN (e.g., the last four numbers of the PAN), a PAN product ID, a token requester ID/indicator, a token assurance level, a token assurance data, a valid period of the token, a token cryptogram, an encryption key, values provided from the token service provider {e.g., a one-time password (OPT)}, or the like. The token may be controlled (for example, activated, suspended, resumed, or disposed) depending on the status of the token service provider. The token may be static information corresponding to the card information (e.g., the PAN).

According to various embodiments of the present disclosure, the payment circuit 1121 may determine a card for performing payment. For example, at least one payment management circuit 1131 may be configured to determine a payment circuit corresponding to the card selected by the user. The payment management circuit 1131 may be configured to transmit information on the determined card to the payment relay circuit 1141. The payment relay circuit 1141 may be configured to transmit the determined card information to the payment circuit 1121 through the secure environment driver circuit 1153.

According to various embodiments of the present disclosure, the payment circuit 1121 may be configured to manage a list of cards actually used for payment among the held card information. For example, the payment circuit 1121 may be configured to change, based on the determined card information, the list of cards actually used for payment. The change may include increasing the priority for the determined card information in the card list or deleting card information other than the determined card information.

According to various embodiments of the present disclosure, the payment circuit 1121 may receive a key {e.g., a limited used key (LUK) or a single used key} for creating a token cryptogram through the token service provider or the payment server (e.g., the payment service server or the token requester server). The key may be transmitted through a data network, SMS, or the like, and may be transmitted through a secure channel from the token service provider. The secure channel may include a logical channel for encrypting data exchanged using a key different from the key (for example, by a method of using a public key or a private key).

According to various embodiments of the present disclosure, the payment circuit 1121 may include a circuit for generating a key for creating a token cryptogram therein. For example, the electronic device may receive a circuit for generating the key through the token service provider or the payment server, or the circuit for generating the key may be included in the electronic device in the manufacturing process thereof.

According to various embodiments of the present disclosure, the payment circuit 1121 may be configured to create a token cryptogram using the key (e.g., a limited used key or a single used key) for creating the token cryptogram. The payment circuit 1121 may be configured to use different keys according to a predetermined rule, such as every transaction, a predetermined number of transactions, transactions within a predetermined time, and the like.

According to various embodiments of the present disclosure, the payment circuit 1121 may be configured to transmit, to an external electronic device, information including a token, a token valid period, a token requester ID, a token cryptogram, and the like. For example, the payment circuit 1121 may be configured to transfer the payment data to the POS through an MST communication circuit or an NFC communication circuit.

According to various embodiments of the present disclosure, the payment circuit 1121 may transmit and receive information specified in the payment operation to and from the POS device. The communication of the NFC circuit may be performed by the transmission of information from the POS device. The MST circuit may transmit, based on the user's explicit input or the internal algorithm of the electronic device, payment-related information including the token and the token cryptogram to the POS device.

The secure identifier processing circuit 1123 may be configured to obtain, through a user input, input values in relation to the verification necessary for the electronic device or related to the payment. For example, the input values may include a personal identification number (PIN) or card-related information {such as a PAN, a card expiration date, a card vehicle value (CVV), a chip PIN, or an automated teller machine (ATM) PIN, or the like} for the payment execution.

According to various embodiments of the present disclosure, the secure identifier processing circuit 1123 may be configured to display information related to payment through an application. The graphics library, which is necessary for displaying the application of the secure identifier processing circuit on the screen, may be stored in the TEE 1120. The graphics library stored in the TEE 1120 may be different from the graphics library in the REE 1110. The secure identifier processing circuit may be configured to perform user verification, based on an input value, such as a PIN, and to transmit a result thereof to the payment management circuit 1131 through the payment relay circuit 1141.

According to various embodiments of the present disclosure, a secure environment relay circuit 1146 may be configured to receive an encrypted one-time random number (e.g., the nonce) transmitted through the secure environment driver circuit 1153. The secure identifier processing circuit 1123 may be configured to encrypt the input value obtained by the user input and the one-time random number using an encryption key (e.g., a device root key) in the TEE to thus transmit the same to the secure environment relay circuit 1146.

The secure environment relay circuit 1146 may be configured to transmit the encrypted input value and one-time random number to the payment circuit 1121 through the secure environment driver circuit 1153. The payment circuit 1121 may be configured to decrypt the input value and the one-time random number using a hardware key in the TEE 1120, and may be configured to confirm that the input value transmitted through the REE 1110 has integrity if the value for creating the one-time random number matches the value of the transmitted one-time random number.

The payment circuit 1121 may be configured to perform, based on the integrity of the input value, user verification through the input value and to perform payment through the user verification.

According to various embodiments of the present disclosure, a factory reset may include returning a software image of the electronic device to an initial state when it was produced in the factory. The above operation may be performed by the user's explicit operation through an application. In addition, a circuit for monitoring and determining the hacking in a specified condition (for example, when it is determined that the system is hacked) may be configured to perform the factory reset. Since the data stored in the electronic device is reset when the above operation is performed, the payment-related information of the user may be reset as well. For example, when the payment-related information is reset, the old payment-related information prior to the resetting may be stored in the payment server 720.

According to various embodiments of the present disclosure, if the user accesses based on the account stored in the payment server 720, the operations of registering a card and installing the payment circuit may be conducted again based on the payment-related information. When the electronic device is reset, the payment-related circuit stored in the electronic device may be configured to inform the token service provider 730 of the same through the payment server 720 to thus disable the network-related function. If the network of the electronic device is disabled, the notification operation may not be performed. In this case, the electronic device may perform the factory reset, may then access, based on the account, the payment server 720 in order to thereby identify a previously registered card list therefrom, and may allow the token service provider 730 to deactivate function related to the previously registered card circuit or token of the electronic device through the payment server 720. In addition, based on the card list of the payment server 720, the electronic device may re-register the card to thus receive a payment circuit, a token, or the like.

The biometric information circuit 1125 may be configured to confirm the identity of the user by comparing the previously stored user biometric information with information obtained from the biometric sensor. Based on the confirmed information, the biometric information circuit 1125 may be configured to transmit a verification result to the biometric information management circuit 1143 through the secure environment driver circuit 1153, and the biometric information management circuit 1143 may be configured to transmit the same to the payment relay circuit 1141. The payment relay circuit 1141 and the biometric information management circuit 1143 may be configured together as a single circuit, or may be configured as separate circuits.

According to various embodiments of the present disclosure, the biometric information circuit 1125 may be configured to perform verification in order to obtain secure data (e.g., a token) from a secure memory {e.g., an embedded secure element (eSE) or an accessible memory in a secure environment}, which is operatively connected to the electronic device, when the user attempts to make a payment using the card information registered in the electronic device. The electronic device may obtain user biometric information (e.g., a fingerprint or an iris) through a biometric information circuit for user verification. The obtained biometric information may be transmitted to the biometric information management circuit 1143 of the payment manager 1140. According to an embodiment, the secure memory may include a memory storing data using an encrypted key.

According to various embodiments of the present disclosure, the biometric information circuit 1125 may be configured to allow the user to make a payment using the card information and the biometric information registered in the electronic device when performing an electronic payment in the web page of the Internet. The user may perform verification in order to obtain secure data (e.g., a token) from a memory or a secure circuit (e.g., the eSE or the accessible memory in the secure environment), which is operatively connected to the electronic device. When the user verification is performed successfully in the electronic device, it is possible to conduct fast automatic verification {e.g., fast identity online (FIDO)} without a separate electronic payment process on the Internet web page by interworking with an external server. That is, the verification process necessary for the online payment can be rapidly performed by associating the same with the biometric information circuit.

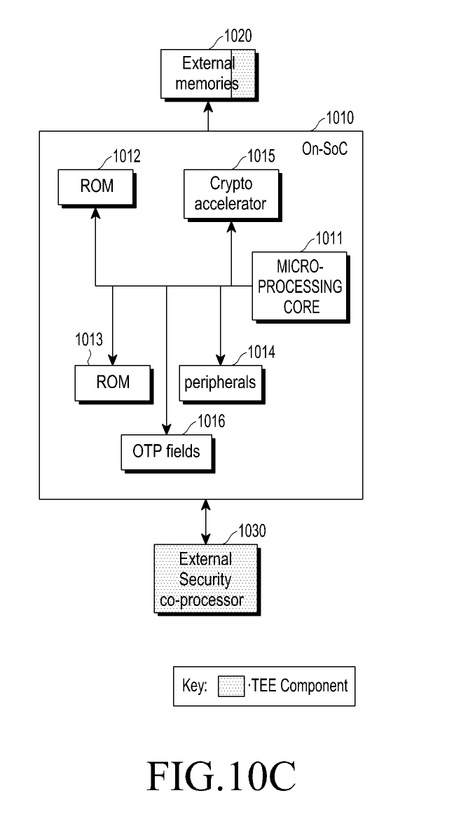

FIG. 12 is a block diagram illustrating an example of a structure of a payment server, according to various embodiments of the present disclosure.

Referring to FIG. 12, a payment server 1200 of a payment system may include a trusted service management 1210, a payment service server 1220, or a token requester server 1230.

The trusted service management server 1210 may manage information related to payment. For example, the trusted service management server 1210 may manage information related to payment according to the type (e.g., security area or non-security area) and/or the configuration (e.g., logical configuration or physical configuration) of the area storing the payment-related information. For example, if the area storing the payment-related information token is a secure circuit (e.g., the eSE) or an embedded subscriber identity module (eSIM), the trusted service management server 1210 may manage the token stored in the secure circuit or the eSIM. The secure circuit or the eSIM may be included in the electronic device or an external device.

According to various embodiments of the present disclosure, the trusted service management server 1210 may perform the functions of the payment service server 1220 and/or the token requester server 1230. In addition, the trusted service management server 1210 may be provided separately from the payment service server 1220 and/or the token requester server 1230. For example, the payment service server 1220 and/or the token requester server 1230 may be provided in a first server, and the trusted service management server 1210 may be provided in a second server.

According to various embodiments of the present disclosure, the trusted service management server 1210 may control a storage element (e.g., a memory) storing the payment-related information (e.g., a token or a key) in order to manage the payment-related information. The storage element for storing the payment-related information may include a key management system.

According to various embodiments of the present disclosure, the trusted service management server 1210 may manage the token stored in the secure circuit or the eSIM using the key management circuit. A storage area included in the secure circuit or the eSIM may include a supplementary secure domain (SSD). The SSD may be included in the electronic device, and may be generated using a key management circuit agent or client. The key management circuit agent or client may be operatively connected to the key management circuit to thus perform a payment function.

According to various embodiments of the present disclosure, the electronic device may include a specified key when producing or processing the electronic device. For example, the electronic device may generate a master key in a specified area (e.g., a secure circuit or eSIM) using the specified key.

According to various embodiments of the present disclosure, the electronic device may generate the SSD in the specified area using the master key in response to a request from the trusted service management server 1210.

According to various embodiments of the present disclosure, the SSD may include a profile or an application (e.g., SDK) necessary for a bank or a financial company to perform a payment function, respectively. The profile or application may be installed in the SSD through the trusted service management server 1210.

The payment service server 1220 may include at least one of a payment service circuit 1221, a card management circuit 1222, or an account management circuit 1223. For example, the payment service server 1220 may store information related to an electronic device or an account.

According to various embodiments of the present disclosure, the payment service circuit 1221 may be operatively connected to the payment application included in the electronic device in order to thereby provide an API for transmitting and receiving payment-related information. The payment service circuit 1221 may also be configured to record the flow of information (e.g., data) in relation to the payment. For example, the flow of payment-related information may include storing a payment result, transmitting transaction details to the electronic device, or retrieving a payment history.

According to various embodiments of the present disclosure, the card management circuit 1222 may be configured to generate information about a card received from the payment application. For example, the card management circuit 1222 may be configured to generate a resource ID in relation to the card information received from the payment application. The resource ID may be expressed as “resour.ID”. The card information received from the payment application may be transmitted to the payment service server 1220 in response to a command indicating a card for payment from the user (e.g., a registration request). The resource ID may include a user ID, an electronic device ID, at least one token ID, or token reference information. The token reference information may include specified information in order to identify each piece of card information using the token ID.

According to various embodiments of the present disclosure, the card management circuit 1222 may be configured to transfer the token ID or token reference information to the token requester server 1230 included in the payment server 1210. For example, the card management circuit 1222 may be configured to transfer a registration request for the card information to a token service interface included in the token requester server 1230.

According to various embodiments of the present disclosure, the card management circuit 1222 may be configured to manage a life cycle of the card corresponding to the token ID or token reference information. For example, the life cycle of the card may include at least one of card registration, token issuance, token activation, or token disposal.

The account management circuit 1223 may be configured to manage an account corresponding to the registered card using the card management circuit 1222. For example, the account management circuit 1223 may be configured to provide a payment service by associating a card registered in the payment server 1210 with a service account (e.g., a Samsung account). In addition, the account management circuit 1223 may be configured to perform functions, such as account registration, logging-on, verification, or secure space creation, or may be configured to manage at least one policy for each country, device, or card with respect to the functions.

The token requester server 1230 may include at least one of a payment service interface, a message gateway, or a data management circuit 1233.

The payment service interface may include a token service interface 1231, and the message gateway may include a push gateway circuit 1232.

According to various embodiments of the present disclosure, the token requester server 1230 may be operatively connected to the token server in order to thereby perform at least one of issuing, deleting, or activating a token, and may interwork with the trusted service management server 1210 in order to thereby store the token in a secure space (e.g., the TEE) of the electronic device. In addition, the token requester server 1230 may manage a secure channel with the token server, and may conduct data collection (or ingestion) for information related to the payment or a service function.

The token service interface 1231 may transfer a token-related request received from the electronic device to the token server, and may transfer a response to the request, which is received from the token server, to the electronic device. In addition, the token service interface may manage the security for the channel operatively connected to the token server.

The push gateway circuit 1232 may be configured to perform a passage function for transferring a token-related message from the token server to the electronic device.

The data management circuit 1233 may be configured to manage data used in the token requester server 1230 (e.g., card information or user information). The data management circuit 1233 may also be configured to provide a mapping table such as card information (e.g. a PAN), payment application information, a user, or an electronic device. For example, the mapping table may include at least one of a PAN, payment application information, user information, device information, or token information in the form of a table.

According to various embodiments of the present disclosure, the token requester server 1230 may confirm the mapping table in relation to the token using the data management circuit 1233. For example, the payment server 1500 may perform user verification using the mapping table or information related to the electronic device or the account.

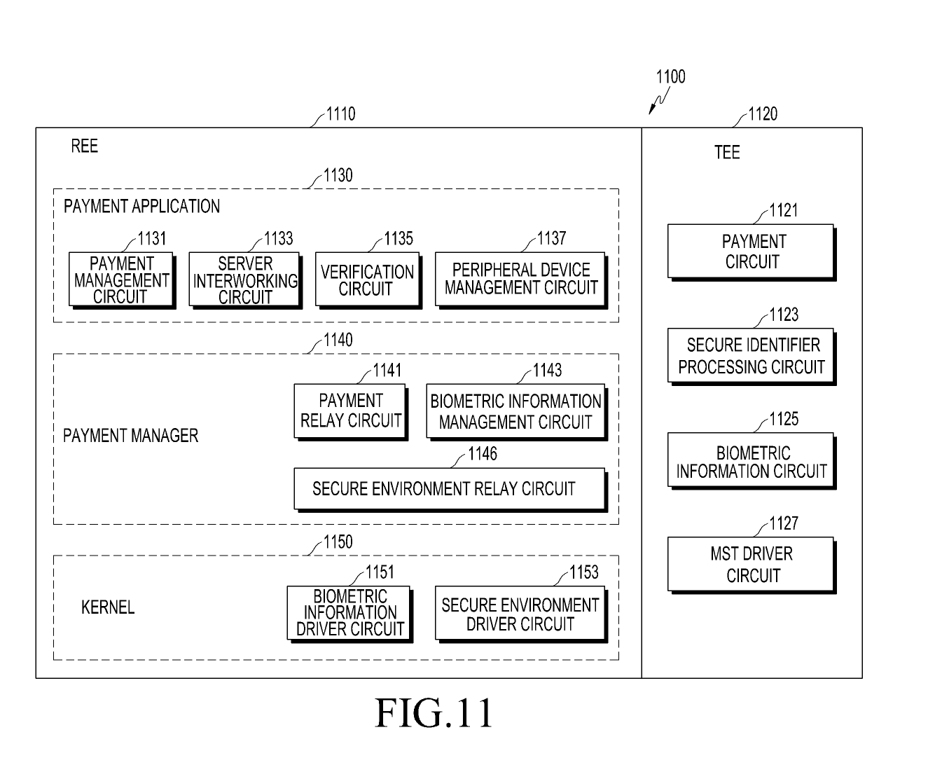

FIG. 13 is a view illustrating an example of a structure of a server, according to various embodiments of the present disclosure.

Referring to FIG. 13, the token server 1300 may perform token issuance or token management.

The token server 1300 may include a token requester interface 1310, a tokenization service circuit 1320, or an issuer interface 1330.

The token requester interface 1310 may include an interface for receiving a request for token issuance from the token requester server.

The tokenization service circuit 1320 may be configured to issue, based on card information (e.g., the PAN), a token when a request for token issuance is received from the electronic device. In addition, the tokenization service circuit 1320 may be configured to perform a function of comparing the token received with the card information when performing payment. For example, the tokenization service circuit 1330 may be configured to proceed with a payment transaction if the card information is the same as, corresponds to, or matches the token received during the payment transaction, or may be configured to stop the payment transaction if the card information is different from, does not correspond to, or does not match the token received during the payment transaction.

When a token is issued to the electronic device or the user receives a token when performing payment, the issuer interface 1330 may provide an interface with the financial server for token verification by the financial server.

According to various embodiments of the present disclosure, the token server 1300 may include a user ID, an electronic device ID, a card ID (e.g., a card reference ID), or a resource ID (e.g., token reference information). The user identification information may include information of a service account (e.g., a Samsung account) used for the payment function, and may be used to manage an electronic device, which has been registered under the user information or the user account. The card ID may include registration information (e.g., an enrollment ID) or an ID issued (generated) for each card at the time of card registration, or may include information for identifying each card. The token reference information may include information on the token included in the token server 1300 and a location where the LUK is stored.

According to various embodiments of the present disclosure, the token server 1300 may create a token ID, based on the user ID, the card ID, or the electronic device ID. If at least one of the user ID, the card ID, or the electronic device ID is changed, the token ID may be newly created. For example, the user ID may include at least one electronic device ID, and the electronic device ID may include at least one card ID.

According to various embodiments of the present disclosure, the resource ID may include information related to the user ID, the electronic device ID, and the card ID. In addition, the resource ID may include a token ID, and information (e.g., a token, a PAN, a LUK, or the like) stored in the token server may be identified using the token ID.

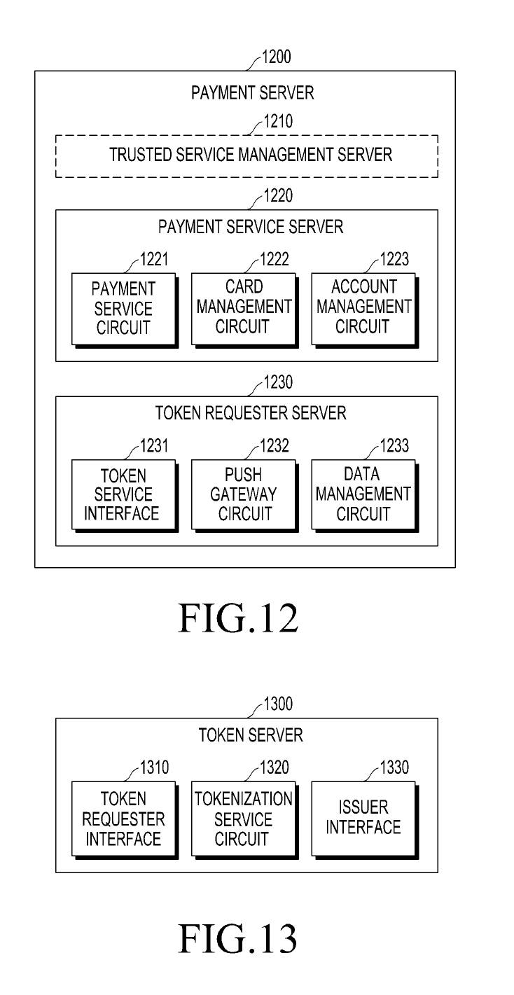

FIG. 14 is a flowchart illustrating an example of a payment operation, according to various embodiments of the present disclosure.

Referring to FIG. 14, the electronic device may transmit payment data in operation 1410. For example, the electronic device may identify a token or a cryptogram corresponding to the payment data, and may generate and transmit information about the token or the cryptogram in magnetic data. For example, the token or the cryptogram may be received by a server (e.g., the payment server or the token server), and when the server transmits the information about the token or the cryptogram to the electronic device, the transmitted information about the token or the cryptogram may be synchronized with the information stored in the user account of the electronic device.

According to various embodiments of the present disclosure, the magnetic data may be obtained by converting payment data by means of an MST circuit (see 910). For example, the electronic device may transmit the magnetic data, which has been converted from the payment data, to a payment device (e.g., the POS) through a payment application.

The electronic device may check whether or not a payment response message is received in operation 1420. For example, the payment response message may be received in the form of a message (e.g., SMS or MMS) through data communication (e.g., 2G, 3G, LTE, Wi-Fi, or the like).

According to various embodiments of the present disclosure, the content of the payment response message may include token information, key information, or an identification number corresponding to the token or key, which has been used for payment, payment amount information, or payment execution result information.

If it is determined that the payment response message has not been received as a result of performing the above operation 1420, the electronic device may confirm that the payment has failed in operation 1431. For example, if the payment response message is not received within a predetermined period of time, or if the payment execution result information includes payment failure information, the electronic device may confirm that the payment has failed.

In operation 1432, the electronic device may identify the token or key used in the failed payment, and may store the same. For example, if the payment response message is not received within a predetermined period of time, the electronic device may determine that the key transmitted for payment has not been used, and may store the used key.

According to various embodiments of the present disclosure, if the payment execution result information includes payment failure information, the key used in the payment may be deleted.

According to various embodiments of the present disclosure, the stored key may be reused in the subsequent payment operation (for example, in operation 1410). For example, if a payment notification message is not received within a predetermined period of time, the key used in the corresponding payment may be stored and then reused later.

If it is determined that a payment response message has been received as a result of performing the above operation 1420, the electronic device may delete the key used for payment in operation 1441. For example, when a notification of the token is received, the electronic device may determine that the key transmitted for payment has been used, and may delete the used token or key.

In 1442 operation, the electronic device may request a token or key again. For example, the electronic device may make a request to the token server for issuance of the token or key.

According to various embodiments of the present disclosure, a method of performing a payment transaction in an electronic device may include: transmitting, to a payment device, payment data generated using verification information in response to a payment request input through the electronic device; checking whether or not a payment response message including payment execution result information using the payment data is received; and managing stored verification information depending on whether or not the payment response message is received within a predetermined period of time.

According to various embodiments of the present disclosure, the verification information may include key information for decrypting a cryptogram included in the payment data.

According to various embodiments of the present disclosure, the information related to the payment execution may include information indicating whether or not first verification information has been used for the payment request.

According to various embodiments of the present disclosure, the payment data may be transmitted in an magnetic stripe transmission (MST) manner.

According to various embodiments of the present disclosure, the payment response message may include at least one piece of verification information used for payment, newly issued verification information, payment amount information, or payment execution result information.

The method of performing a payment transaction in an electronic device, according to various embodiments of the present disclosure, may further include: if the payment response message is received within a predetermined period of time, confirming whether or not the payment using the payment data has been performed by checking the received payment response message; and if it is confirmed that the payment using the payment data has been performed, deleting first verification information from the stored verification information.

The method of performing a payment transaction in an electronic device, according to various embodiments of the present disclosure, may further include: making a request to a server for issuing new verification information by identifying the number of pieces of the stored verification information; receiving newly issued verification information in response to the request for new verification information; and storing at least one piece of the received verification information in a memory to thus manage the stored verification information.

The method of performing a payment transaction in an electronic device, according to various embodiments of the present disclosure, may further include transmitting identification information of the electronic device through communication with the server, wherein the identification information of the electronic device may include at least one of a telephone number, an internet protocol (IP) address, or a media access control (MAC) address of the electronic device.

The method of performing a payment transaction in an electronic device, according to various embodiments of the present disclosure, may further include performing communication with the server through a secure channel.

The method of performing a payment transaction in an electronic device, according to various embodiments of the present disclosure, may further include managing the stored verification information such that first verification information is not to be deleted if the payment response message is not received within a predetermined period of time.

The method of performing a payment transaction in an electronic device, according to various embodiments of the present disclosure, may further include: generating second payment data using the first verification information when second payment is requested; and transmitting the generated second payment data to the payment device.

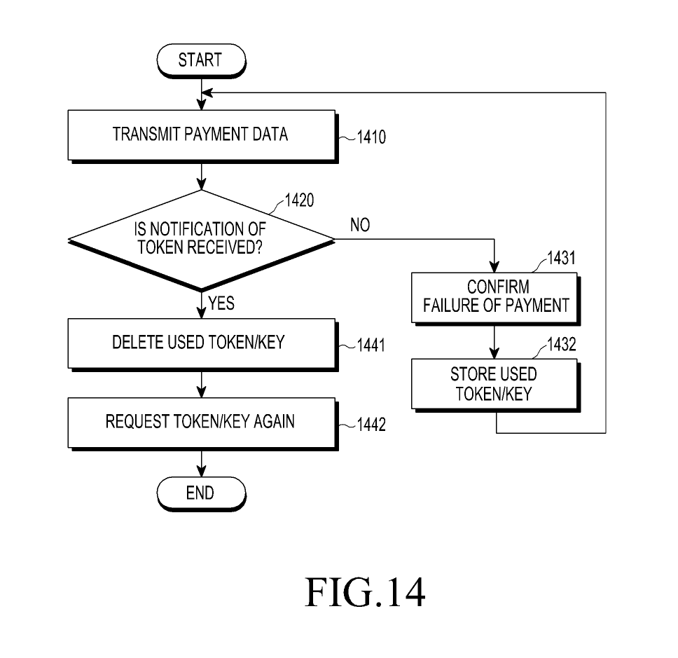

FIG. 15 is a flowchart illustrating an example of an operation in which a server transmits a payment response message, according to various embodiments of the present disclosure.

Referring to FIG. 15, the server (e.g., the payment server 1200) may confirm that payment using the token is performed in operation 1510. For example, the server may receive, through the token server, a payment response message indicating that the payment using the token is performed.

In operation 1520, the server may identify a user account, based on the information about the token or key included in the payment response message.

In operation 1530, the server may identify identification information of the user account to which the token has been issued by checking the token information. For example, the identification information of the user account may include an account ID, a telephone number, electronic device identification information, network identification information {e.g., IP (internet protocol) information}, or the like, or may have a variety of information for identifying the user account. In operation 1540, the server may identify the electronic device registered in the identified account, and may transmit, to the electronic device, a payment response message including the information on the token or key used for payment. For example, the payment response message may be transmitted in the form of a data packet, an SMS, or the like in a push manner.

For example, a method of performing communication in a server, according to various embodiments of the present disclosure, may include: when first payment data is received from an external electronic device, confirming first verification information included in the received first payment data; determining whether or not the payment corresponding to the first payment data is executable using the first verification information; and transmitting the determination result to the external electronic device.

The method of performing communication in a server, according to various embodiments of the present disclosure, may further include, when a message of request for new verification information is received from the external electronic device, issuing second verification information in response to the request and transmitting the same to the external electronic device.

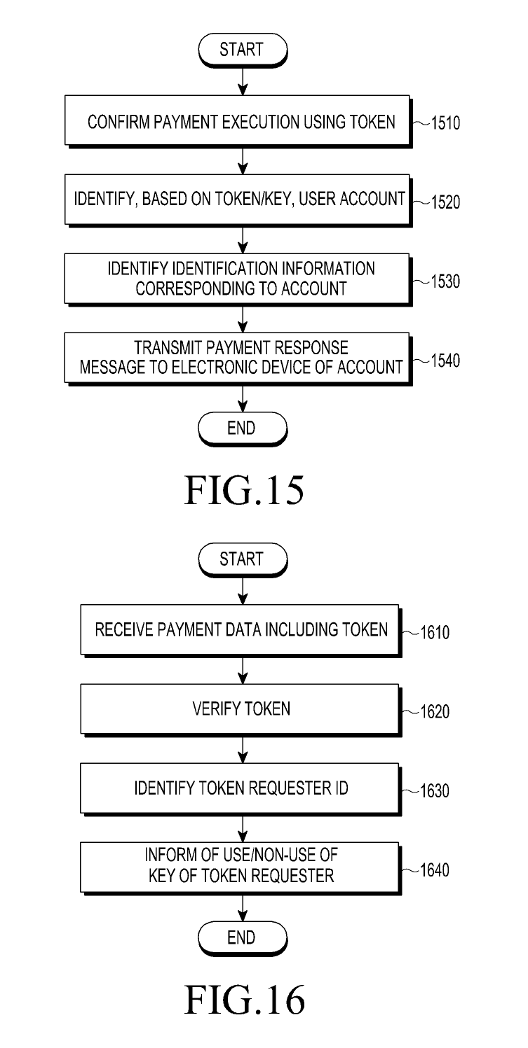

FIG. 16 is a flowchart illustrating an example of an operation in which a server transmits a notification of token usage, according to various embodiments of the present disclosure.

Referring to FIG. 16, the server may receive payment data including a token in operation 1610. For example, the server may include a token service provider.

In operation 1620, the server may verify the received token. For example, the server may determine whether or not the corresponding token is valid by checking the token information (e.g., a token valid period), or may verify the corresponding token by determining whether or not the token matches the card information stored for issuing the token.

The server may identify a token requester ID in operation 1630.

In operation 1640, the server may inform the electronic device corresponding to the token requester ID of the use/non-use of the key for the payment. For example, in the case where if the payment is made using a token in the electronic device (e.g., the electronic device 110, the electronic device 111, or the accessory 112) of the user, the key may be used to encrypt the cryptogram among the payment data. The key may be created by the server, and may be transmitted to the electronic device of the user.

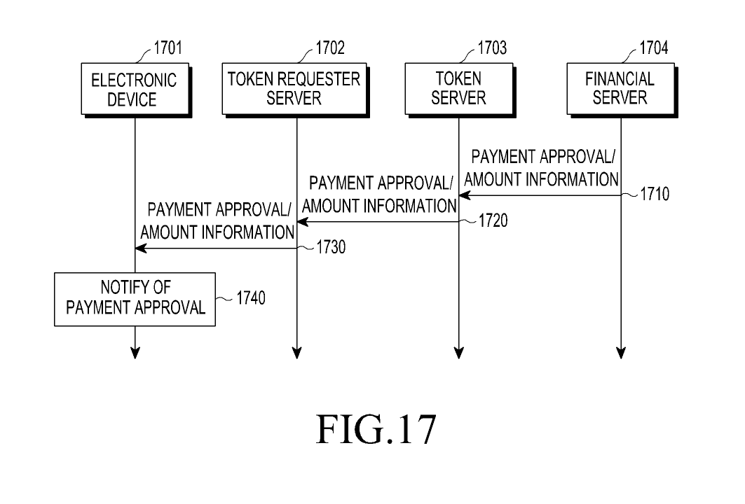

FIG. 17 is a flowchart illustrating an example of a payment operation in a payment system, according to various embodiments of the present disclosure.

Referring to FIG. 17, the payment system may include an electronic device 1701, a token requester server 1702, a token server 1703, or a financial server 1704. The token requester server 1702 may be the same as the token requester server 1230 of the payment server 1200 in FIG. 12.

In operation 1710, the financial server 1704 may transmit payment approval/disapproval or amount information to the token server 1703. For example, the electronic device 1701 may transmit payment data to a payment device (e.g., the POS), and the financial server 1704 may transmit payment-related information in response thereto.

According to various embodiments of the present disclosure, when the payment approval is completed, the confirmed information on the payment approval/disapproval and information on the transaction amount may be transferred from the financial server 1704 to the token server 1703 or the token requester server 1702.

In operation 1720, the token server 1703 may transfer the received payment approval/disapproval information or the amount information to the token requester server 1702.

According to various embodiments of the present disclosure, the token requester server 1702 may check the transferred information to thus confirm that the payment approval has been performed, and may delete the key used for the payment approval.

In operation 1730, the token requester server 1702 may transfer the transmitted payment approval/disapproval information or the amount information to the electronic device 1701.

According to various embodiments of the present disclosure, the electronic device 1701 may include a secure circuit (e.g., the SE), a TEE, or an REE, and the payment-related information transmitted from the token requester server 1702 may be transmitted through at least one of a payment application (e.g., 1030), a payment manager (e.g., 1040), or a payment circuit (e.g., 1021) in the TEE. The transmitted payment-related information may be stored in the electronic device in accordance with a secure circuit (e.g. the SE) or an execution environment having a security level (e.g. the TEE or the REE).

In operation 1740, the electronic device 1701 may inform that the payment approval is completed.

According to various embodiments of the present disclosure, in the case where a payment application is displayed on the front surface of a display (in the foreground state), the electronic device 1701 may display the information related to the payment approval to the user through the payment application. For example, when the payment application is executed as a background or is executed, as a program (e.g., daemon), in the payment application, the notification of the payment approval or the amount information may be provided to the user in the form of a pop-up message or a notification message, or the payment approval or the amount information may be stored in the electronic device as a history without being notified to the user.

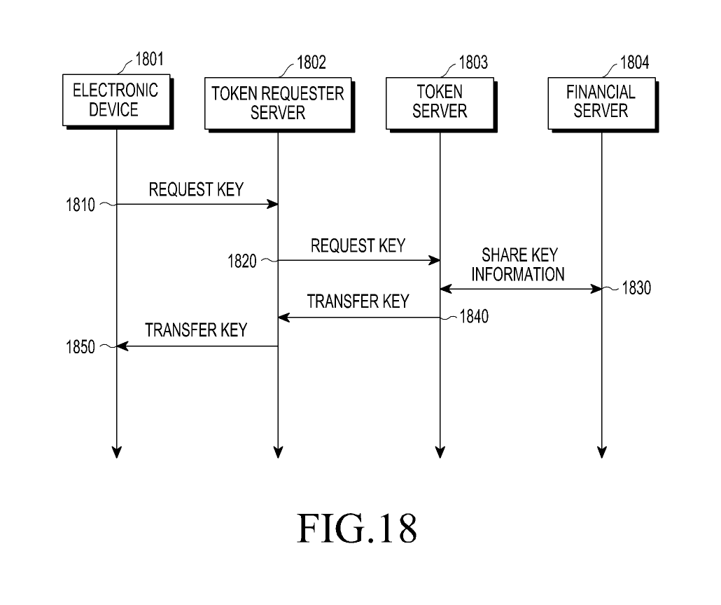

FIG. 18 is a flowchart illustrating an example of a key request operation in a payment system, according to various embodiments of the present disclosure.

According to various embodiments of the present disclosure, the key for payment may be set to be available for a predetermined period of time or a predetermined number of usage times (e.g., a limited use key). Accordingly, the electronic device may identify the key that has been used more than a predetermined period of time or more than a predetermined number of usage times, and may make a request to the token server 1803 for issuing a key.

Referring to FIG. 18, the payment system may include an electronic device 1801, a token requester server 1802, a token server 1803, or a financial server 1804.

In operation 1810, the electronic device 1801 may transmit a request for a key to the token requester server 1802.

According to various embodiments of the present disclosure, the electronic device 1801 may transmit a key request message to a server (e.g., the token requester server 1802).

In operation 1820, the token requester server 1802 may transmit the key request message to the token server 1803.

In operation 1830, the token server 1803 may issue a token or a key, and may share information about the issued token or key with the financial server 1804.

In operation 1840, the token server 1803 may issue a key in response to the key request, and may transmit the issued key to the token requester server 1802.

In operation 1850, the token requester server 1802 may transfer, to the electronic device 1801, the key issued in response to the key request.

According to various embodiments of the present disclosure, the electronic device 1801 may transmit the key transferred from the server (e.g., the token requester server 1802) to at least one of a payment application (e.g., 1030), a payment manager (e.g., 1040), or a payment circuit (e.g., 1021) in an execution environment having a security level (e.g., the TEE). The transferred key may be encrypted, and may be stored in memory through the execution environment having a security level (e.g., the REE or the TEE), or may be stored in a secure circuit (e.g., the SE).

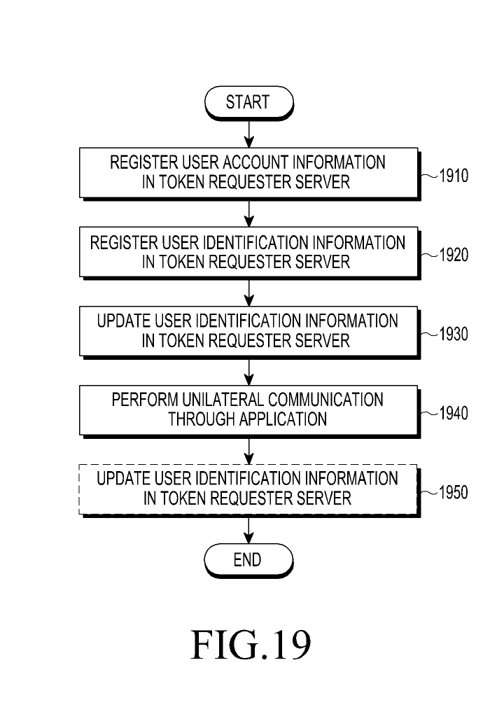

FIG. 19 is a flowchart illustrating an example of an operation in which an electronic device manages user identification information, according to various embodiments of the present disclosure.

Referring to FIG. 19, the electronic device may register user account information in the token requester server in operation 1910

In operation 1920, the electronic device may register user identification information (e.g., an IP address or a telephone number) in the token requester server. For example, the electronic device may register the user identification information through the registered user account information.

In 1930 operation, the electronic device may update the user identification information in the token requester server. For example, when the electronic device confirms a change, in part, in the user identification information, the electronic device may make a request to the token requester server for updating the user identification information.

In operation 1940, the electronic device may perform unilateral communication (e.g., magnetic data transmission) through an application. For example, the electronic device may perform communication using the updated user identification information.

In 1950 operation, the electronic device may update the user identification information in the token requester server. For example, if the IP address of the electronic device is changed, the electronic device may make a request to the token requester server for updating the IP address.

According to various embodiments of the present disclosure, if it is confirmed that the user identification information stored in the token requester server has not been changed, the operation 1950 may be omitted or changed.

According to various embodiments of the present disclosure, the token requester server may identify the IP address or telephone number of the electronic device in order to transmit a notification in relation to key usage to the electronic device through an SMS message or a data packet. Accordingly, the electronic device may periodically transmit, to the token requester server, a request for updating the user identification information.

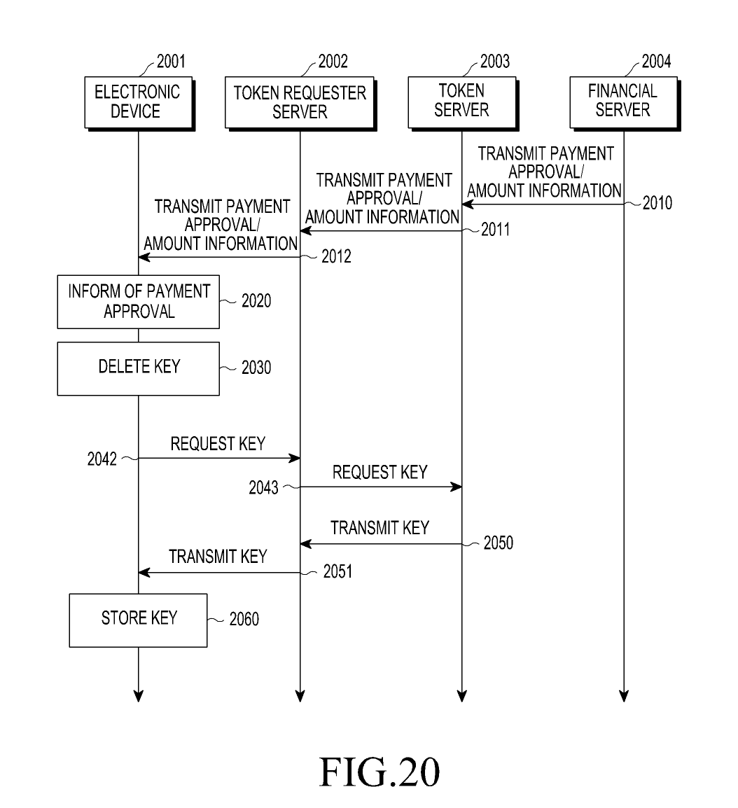

FIG. 20 is a flowchart illustrating an example of an operation in which a payment system manages a key according to payment approval, according to various embodiments of the present disclosure.

Referring to FIG. 20, the payment system may include an electronic device 2001, a token requester server 2002, a token server 2003, or a financial server 2004.

In operation 2010, the financial server 2004 may confirm information related to the payment approval, and may transmit, to the electronic device 2001, the payment approval information or the payment approved amount information. For example, the payment approval or amount information may be transmitted from the financial server 2001 to the token requester server 2002 through the token server 2003 (operation 2011), and the token requester server 2002 may transfer the received information to the electronic device 2001 (operation 2012).

According to various embodiments of the present disclosure, the electronic device 2001 may include an SE, a TEE, or an REE, and the electronic device 2001 may notify, based on the transmitted payment approval or amount information, of the payment approval, and may delete the key used for the payment approval.

In operation 2020, the electronic device 2001 may output (for example, display) the payment approval notification. For example, the payment approval notification may include information indicating that the payment has been approved by the financial server 2004, and may be output in the form of a message.

In operation 2030, the electronic device 2001 may delete the key. For example, a key deletion command may be transmitted to the TEE.

In operation 2042, the electronic device 2001 may request a new key. For example, if the key is deleted through the SE, the electronic device 2001 may make a request for a new key to the token requester server 2002.

According to various embodiments of the present disclosure, the key request is transmitted from the TEE of the electronic device 2001 to the REE, and may be transmitted to the token requester server 2002 through the REE (operation 2042) to then be transmitted to the token server 2003 (operation 2043).

According to various embodiments of the present disclosure, if the token or key information used for the payment does not include payment approval or amount information, as to the token or the key, the electronic device 2001 may request a key depending on whether or not a predetermined number of keys have been deleted. For example, in the case where a plurality of payments cannot be simultaneously executed in a wireless communication environment, the electronic device 2001 may perform control such that another payment is not performed until the payment is completed. The electronic device 2001 may identify the key used for the previously performed payment through the received payment approval/disapproval or amount information to thus delete the corresponding key, and may request a new key.

In operation 2050, the token server 2003 may issue a key in response to the key request, and may transmit the issued key to the token requester server 2002.

In operation 2051, the issued key may be transmitted from the token requester server 2002 to the electronic device 2001.

In operation 2060, the electronic device 2001 may store the transmitted key. For example, the electronic device 2001 may transfer the received key to the TEE through the REE, and the TEE may instruct the SE to store the transmitted key.

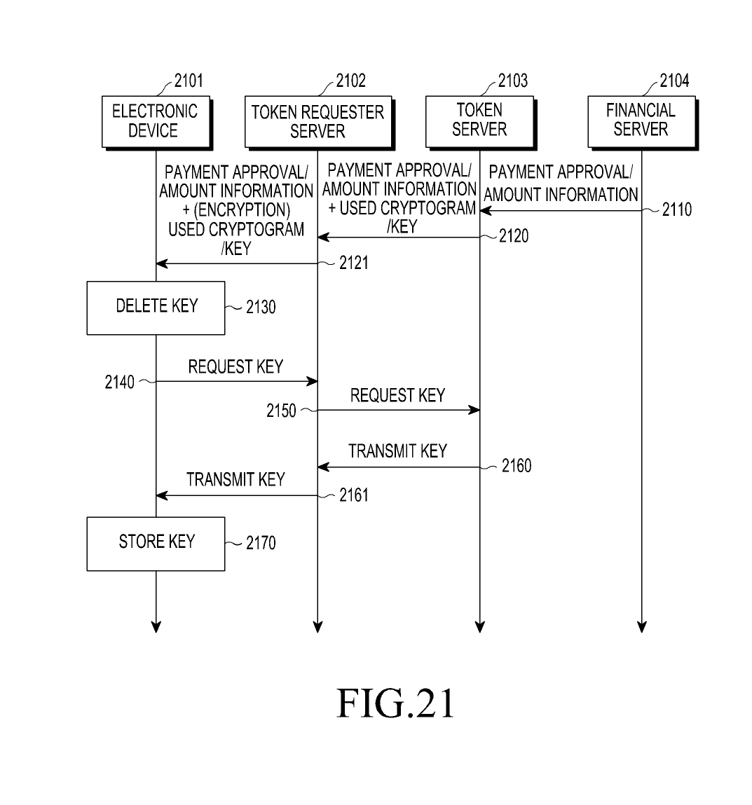

FIG. 21 is a flowchart illustrating an example of an operation in which a payment system manages a key according to payment approval, according to various embodiments of the present disclosure.

Referring to FIG. 21, the payment system may include an electronic device 2101, a token requester server 2102, a token server 2103, or a financial server 2104.

In operation 2110, the financial server 2104 may confirm information related to payment approval, and may transmit, to the token server 2103, the payment approval information or payment approved amount information.

In operation 2120, the token server 2103 may include used cryptogram or key information in the transmitted payment approval information or amount information, and may transmit the same to the token requester server 2102.

According to various embodiments of the present disclosure, the used cryptogram or key may be encrypted by means of a separate encryption process, which is specified between the electronic device 2101 and the token requester server 2102 (for example, using a secure channel between the token requester server 2102 and the electronic device 2101), and may then be transmitted. For example, in the case where the security is sufficiently ensured by means of the communication through the secure channel without a separate encryption process, the encryption process may be omitted.

In operation 2121, the token requester server 2102 may transmit, to the electronic device 2101, the received payment approval information or amount information including the used cryptogram or key information.

According to various embodiments of the present disclosure, the electronic device 2101 may include an SE, a TEE, or an REE.

In operation 2130, the electronic device 2101 may delete the key that has been used for the payment. For example, in the electronic device 2101, a key deletion command may be transmitted from the TEE to the SE in order to thereby delete the key.

According to various embodiments of the present disclosure, since the electronic device 2101 receives information on the used key, even if a plurality of payments are simultaneously performed, the electronic device 2101 may identify the payment for which the key has been used based on the received information. For example, the electronic device 2101 may record a previously used key and payment data corresponding to the key as a pair, and may perform operations of deleting the key and requesting a new key.

In operation 2140, the electronic device 2101 may make a request for a new key to the token requester server 2102.

In operation 2150, the token requester server 2101 may transmit the key request to the token server 2103.

In operation 2160, the token server 2103 may issue a key in response to the key request, and may transmit the issued key to the token requester server 2102.

In operation 2161, the issued key may be transferred from the token requester server 2102 to the electronic device 2101.

In operation 2170, the electronic device 2101 may store the transferred key.

According to various embodiments of the present disclosure, the storage and management of the key may be performed by the SE or using a memory of the TEE in the electronic device 2101.

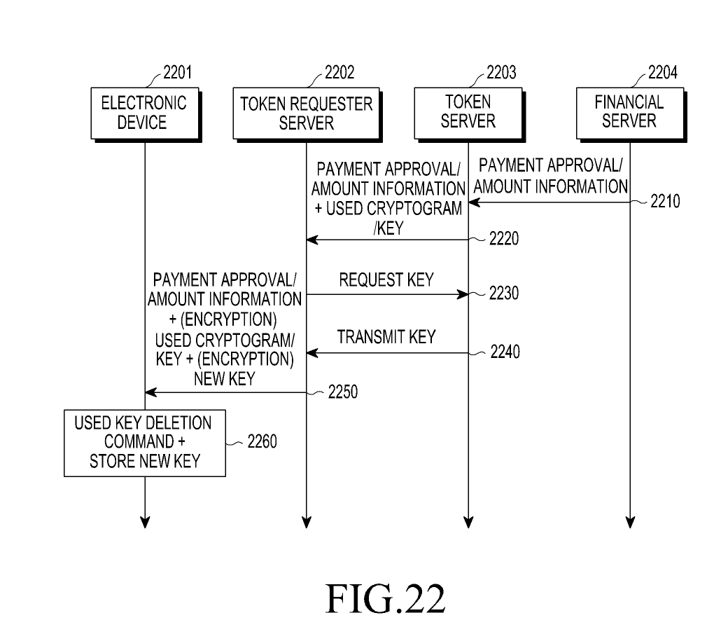

FIG. 22 is a flowchart illustrating an example of an operation in which a payment system manages a key according to payment approval, according to various embodiments of the present disclosure;

Referring to FIG. 22, the payment system may include an electronic device 2201, a token requester server 2202, a token server 2203, or a financial server 2204.

In operation 2210, the financial server 2204 may confirm information related to payment approval, and may transmit payment approval information or approved payment amount information to the token server 2203.

In operation 2220, the token server 2203 may include used cryptogram or key information in the received payment approval information or amount information, and may transmit the same to the token requester server 2202.

In operation 2030, the token requester server 2202 may transmit a key request to the token server 2203.

According to various embodiments of the present disclosure, when the used key is confirmed through the transmitted payment approval information or amount information, the token requester server 2202 may make a request to the token server 2203 for a new key to be used in the electronic device 2201.

In operation 2240, the token server 2203 may issue a new key in response to the key request from the token requester server 2202, and may transmit the same to the token requester server 2202.

In operation 2250, the token requester server 2202 may include the new key information, which has been received in response to the request of the token request server 2202, in the transmitted payment approval information, amount information, or used-cryptogram or key information, and may transmit the same to the electronic device 2201. For example, the used-cryptogram or key information or the new key information may be transmitted to the electronic device 2201 while being encrypted through a secure channel.

According to various embodiments of the present disclosure, the electronic device 2201 may include an SE, a TEE, or an REE.

In operation 2260, the TEE of the electronic device 2201 may instruct the SE to delete the used key or to store the new key.

According to various embodiments of the present disclosure, the electronic device 2201 may delete the used key, and may store the new key in accordance with the received information.

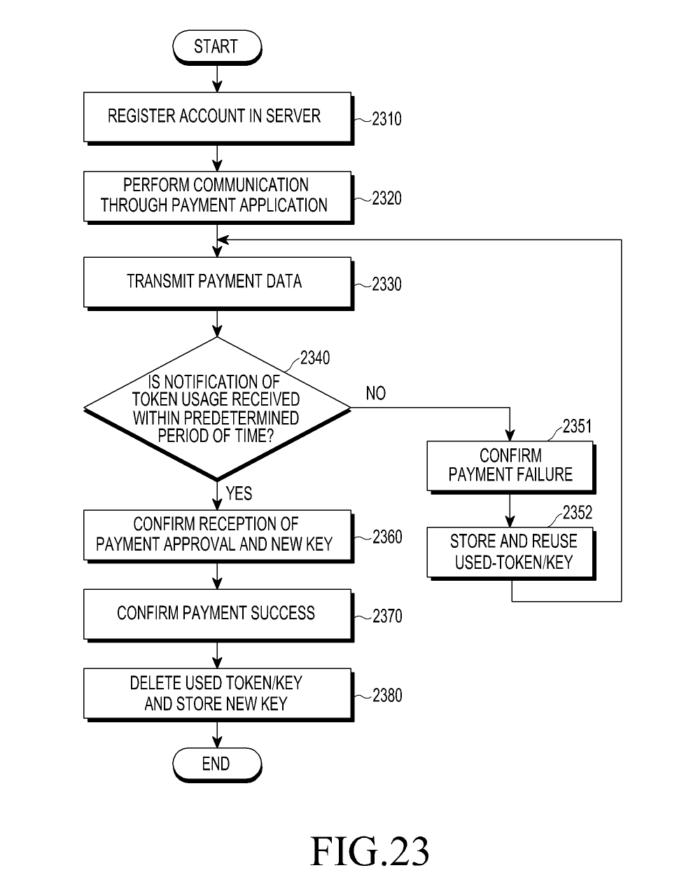

FIG. 23 is a flowchart illustrating an example of an operation in which an electronic device manages a key according to payment approval, according to various embodiments of the present disclosure.

Referring to FIG. 23, in operation 2310, the electronic device may register an account in the server.

In operation 2320, the electronic device may perform communication through a payment application. For example, the communication may include unidirectional communication.

In operation 2330, the electronic device may transmit payment data. For example, the payment data may include magnetic data corresponding to the card information to be used for payment.

In operation 2340, the electronic device may check whether or not a notification of token usage has been received within a predetermined period of time.

As a result of performing the operation 2340, if it is confirmed that a notification of token usage has not been received within a predetermined period of time, the electronic device may confirm that the payment has failed in operation 2351. For example, the payment may fail in the case where the payment approval has failed or invalid payment data (e.g., card information) is contained.

In operation 2352, the electronic device may store and reuse the token or key, which has been used in the payment that is confirmed as a failure. For example, the stored token or key may be included in the payment data to then be transmitted in the subsequent payment execution.

As a result of performing the operation 2340, if it is confirmed that a notification of token usage has been received within a predetermined time, the electronic device may confirm that payment approval and a new key have been received in operation 2360.

In operation 2370, the electronic device may confirm that the transaction was successful when the payment approval and the new key are received. For example, the successful transaction may include a case where the payment approval has been successfully performed.

In operation 2380, the electronic device may delete the used token or key, and may store the received new key.

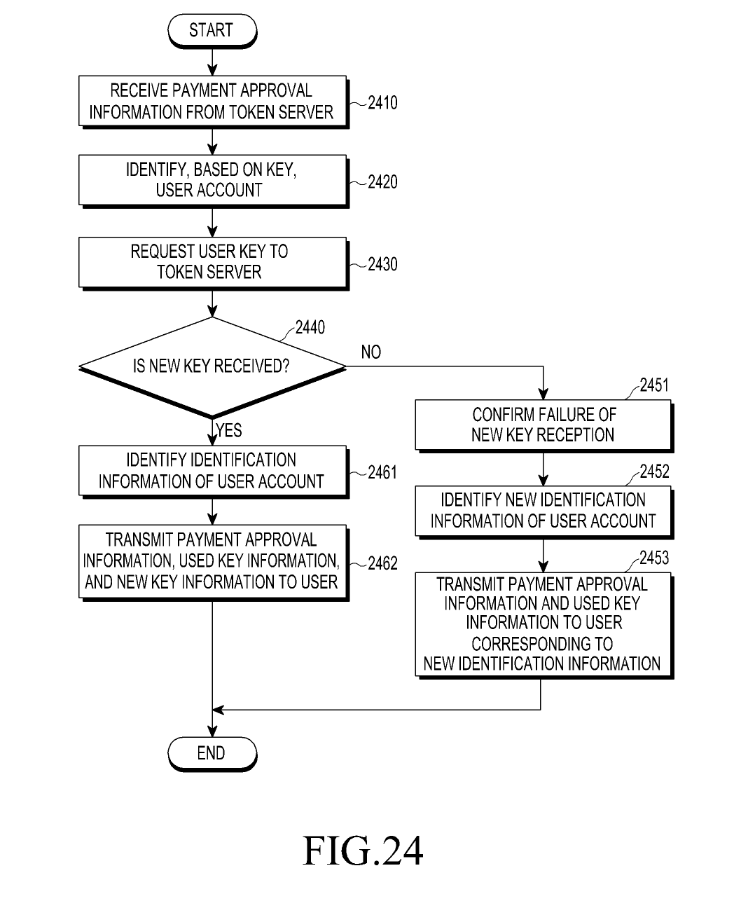

FIG. 24 is a flowchart illustrating an example of an operation in which a server manages a new user key according to payment approval, according to various embodiments of the present disclosure.

According to various embodiments of the present disclosure, the server may include a token requester server.

Referring to FIG. 24, in operation 2410, the server may receive payment approval information from the token server.

In operation 2420, the server may identify a key through the payment approval information, and may identify, based on the key, a user account.

In operation 2430, the server may make a request to the token server for a key for the user of the user account.

In operation 2440, the server may check whether or not a new key has been received.

As a result of performing the operation 2440, if it is confirmed that a new key has not been received, the server may confirm that the reception of a new key has failed in operation 2451.

In operation 2452, the server may identify new identification information in the user account when the reception of the key has failed. For example, the new identification information may be a variety of identification information (e.g., an IP address) other than the identification information for which the reception of the key has failed, among identification information stored in the user account.

In operation 2453, the server may transmit payment approval information and used key information to the user corresponding to the new identification information.

As a result of performing the operation 2440, if it is confirmed that a new key has been received, the server may identify identification information of the user account in operation 2461.

In operation 2462, the server may transmit, to the user, the payment approval information, the used key information, and the new key information.

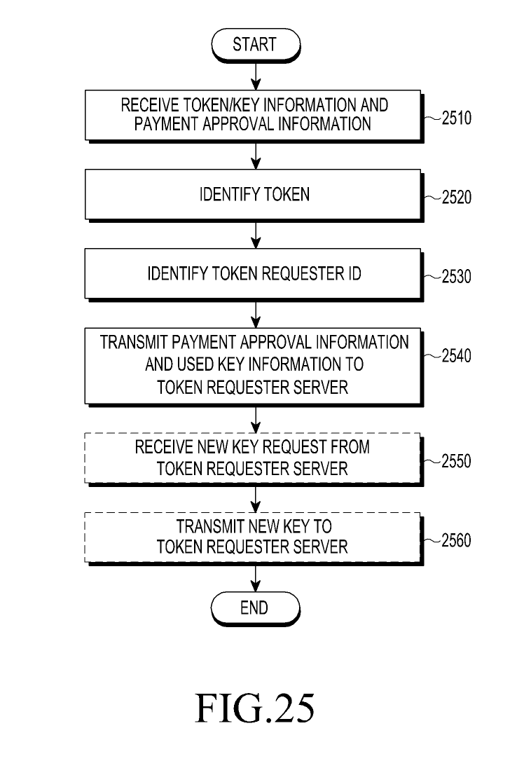

FIG. 25 is a flowchart illustrating an example of an operation in which a server manages a new key according to payment approval, according to various embodiments of the present disclosure.

According to various embodiments of the present disclosure, the server may include a token service provider or a token server.

Referring to FIG. 25, in operation 2510, the server may receive token or key information and payment approval information from a financial server.

In operation 2520, the server may identify the received token information.

In operation 2530, the server may identify a token requester ID from the token information.

In operation 2540, the server may transmit payment approval information and used key information to the token requester server.

In operation 2550, the server may receive a request for issuing a new key from the token requester server.

In operation 2560, the server may issue and transmit a new key to the token requester server in response to the issuance request.

According to various embodiments of the present disclosure, the new key request may not be received within a predetermined period of time depending on the communication status between the server and the token requester server, and in this case, the operation 2550 or the operation 2560 may be omitted or changed.

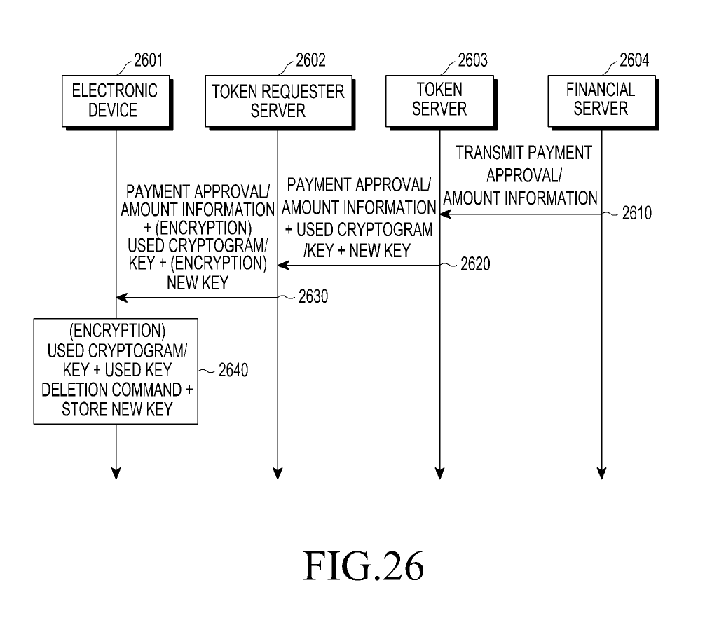

FIG. 26 is a flowchart illustrating an example of an operation in which a payment system manages a new key according to payment approval, according to various embodiments of the present disclosure.

Referring to FIG. 26, the payment system may include an electronic device 2601, a token requester server 2602, a token server 2603, or a financial server 2604.

In operation 2610, the financial server 2604 may transmit payment approval or amount information to the token server 2603.

In operation 2620, the token server 2603 may include a cryptogram or key used for the payment or information on a new key in the transmitted payment approval or amount information, and may transmit the same to the token requester server 2602.

In operation 2630, the token requester server 2602 may transmit the received payment approval or amount information, the used cryptogram or key, or the new key to the electronic device 2601. For example, in the case where the token requester server 2602 communicates with the electronic device 2601 through a specified secure channel, the information on the used cryptogram, key, or new key may be encrypted through the secure channel, or may be encrypted by the token requester server 2602.

According to various embodiments of the present disclosure, the token server 2603 may transfer, to the token requester server 2602, the initially used cryptogram or key information and new key information together with the payment approval or amount information.

According to various embodiments of the present disclosure, the electronic device 2601 may include an SE, a TEE, or an REE.

In operation 2640, the electronic device 2601 may instruct to delete the used cryptogram or key, which has been received, or may store the new key. For example, the electronic device 2601 may transmit, to the TEE, the received information on the used cryptogram or key, or the new key through the REE, and may send a command for deleting the used key or a command for storing the new key to the SE through the TEE.

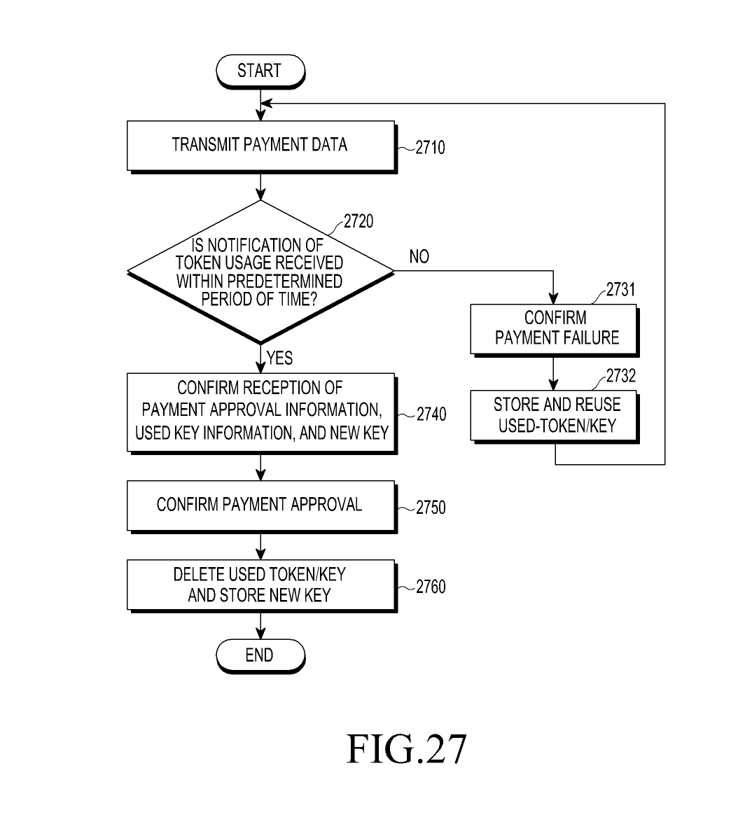

FIG. 27 is a flowchart illustrating an example of an operation in which an electronic device manages a new key according to payment approval, according to various embodiments of the present disclosure.

Referring to FIG. 27, the electronic device may transmit payment data in operation 2710.

In operation 2720, the electronic device may check whether or not a notification of token usage has been received within a predetermined period of time.

If it is confirmed that the notification of token usage has not been received within the predetermined period of time as a result of performing the operation 2720, the electronic device may confirm that the transaction has failed in operation 2731.

In operation 2732, the electronic device may store and reuse the token or key used for the payment, which is confirmed as a transaction failure because the notification of token usage has not been received within a predetermined period of time. For example, when performing subsequent payment, the electronic device may include the token or key for reuse in the corresponding payment data, and may transmit the same.

If it is confirmed that the notification of token usage has been received within the predetermined period of time as a result of performing the operation 2720, the electronic device may confirm that the payment approval information, the used key information, and the new key have been received in operation 2740.

In operation 2750, the electronic device may confirm that the transaction was successful.

In operation 2760, the electronic device may delete the used token or key, and may store the new key.

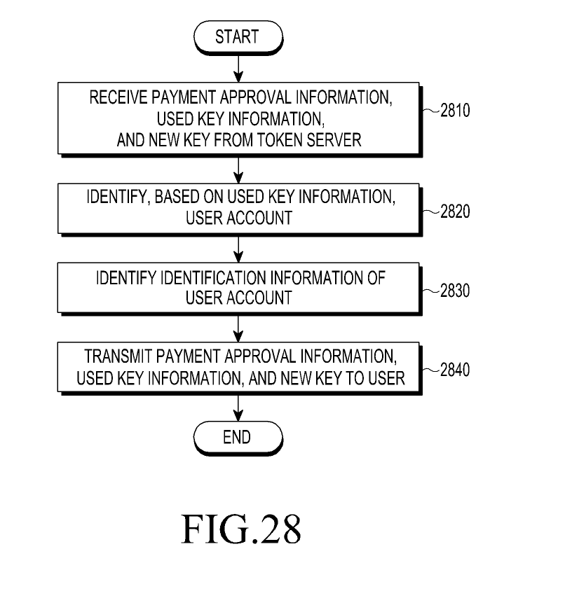

FIG. 28 is a flowchart illustrating an example of an operation in which a server manages a new key according to payment approval, according to various embodiments of the present disclosure.

According to various embodiments of the present disclosure, the server may include a token requester server.

Referring to FIG. 28, in operation 2810, the server may receive payment approval information, used key information, and a new key from a token server (e.g., a token service server).

In operation 2820, based on the received used key information, the server may identify a user account.

In operation 2830, the server may identify at least one piece of identification information from the identified user account.

In operation 2840, the server may transmit the payment approval information, the used key information, and a new key to the user corresponding to the at least one piece of identification information.

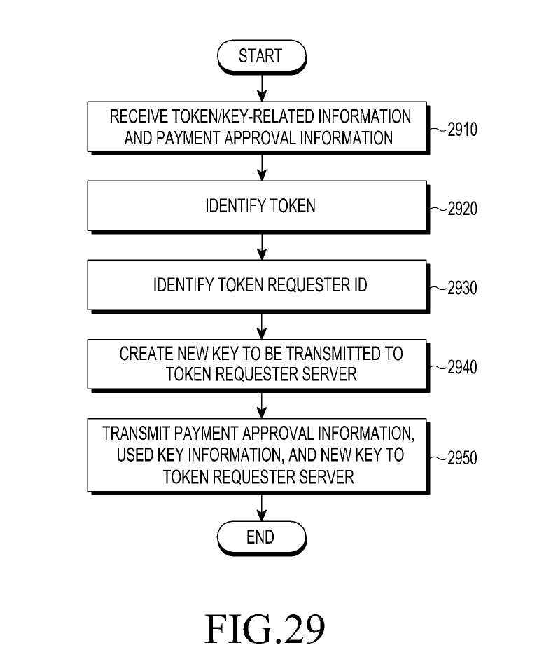

FIG. 29 is a flowchart illustrating an example of an operation in which a server manages a new key according to payment approval, according to various embodiments of the present disclosure.

According to various embodiments of the present disclosure, the server may include a token service provider.

Referring to FIG. 29, in operation 2910, the server may receive token or key-related information and payment approval information.

In operation 2920, the server may confirm the received token.

In operation 2930, the server may identify a token requester ID from the confirmed token.

In operation 2940, the server may create a new key to be transmitted to the token requester server.

In operation 2950, the server may transmit payment approval information, used key information, and a new key to the token requester server.

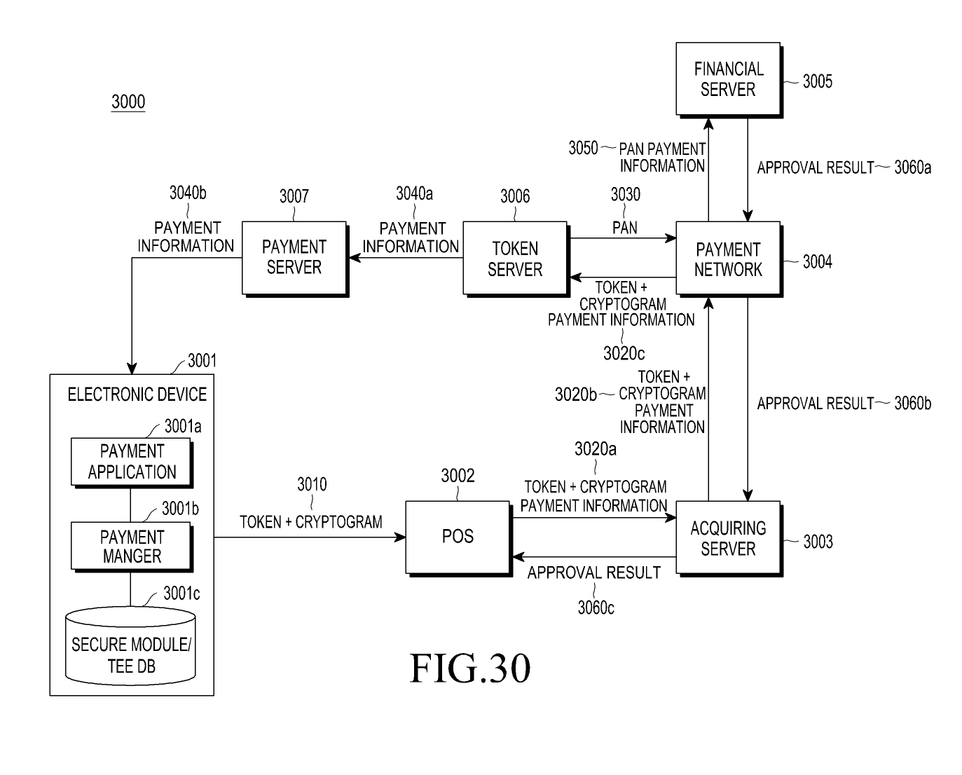

FIG. 30 is a view illustrating an example of the operation of a payment system, according to various embodiments of the present disclosure.

Referring to FIG. 30, the payment system 3000 may be configured to include an electronic device 3001, a payment device (e.g., the POS) 3002, an acquiring server 3003, a payment network 3004, a financial server 3005, a token server 3006, or a payment server 3007. In addition, the payment system may be configured to further include various other configurations related to payment, or may be configured to exclude some of the above configurations while functions thereof are performed by other configurations.

According to various embodiments of the present disclosure, the electronic device 3001 may include a payment application (wallet application) 3001a, a payment manager 3001b, or a secure circuit 3001c. For example, the secure circuit 3001 may be included in the database in the TEE area.

In operation 3010, the electronic device 3001 may transmit token or cryptogram information to the payment device 3002. For example, the token or cryptogram information may include verification information in relation to a card corresponding to the payment requested by the user through the electronic device 3001.

In operation 3020a, the payment device 3002 may include payment information in the transmitted token or cryptogram to thus transmit the same to the acquiring server 3003. For example, the payment information may include the payment amount.

In operation 3020b, the acquiring server 3003 may transmit the transmitted token, cryptogram, or payment information to the payment network 3004.

In operation 3020c, the payment network 3004 may transmit the received token, cryptogram, or payment information to the token server 3006 in order to thereby request card information (e.g., the PAN) corresponding to the token or cryptogram.

Regarding the transmitted token, cryptogram, or payment information, the token server 3006 may transmit card information corresponding to the token or cryptogram, which has been requested to the payment network 3004, in operation 3030, or may transmit payment information to the payment server 3007 in operation 3040a.

In operation 3040b, the payment server 3007 may transmit payment information to the electronic device 3001. For example, the payment information may include information related to the result of the payment approval for the payment request or information related to the usage of the token and cryptogram.

In operation 3050, the payment network 3004 may transmit PAN or payment information to the financial server 3005.

In operation 3060a, the financial server 3005 may transmit a payment approval result using the PAN to the payment network 3004 in response to the transmitted PAN or payment information.

In operation 3060b, the payment network 3004 may transmit the approval result to the acquiring server 3003.

In operation 3060c, the acquiring server 3003 may transmit the approval result to the payment device (e.g., the POS) 3002. For example, the payment device (e.g., the POS) 3002 may output (for example, print out) the approval result.

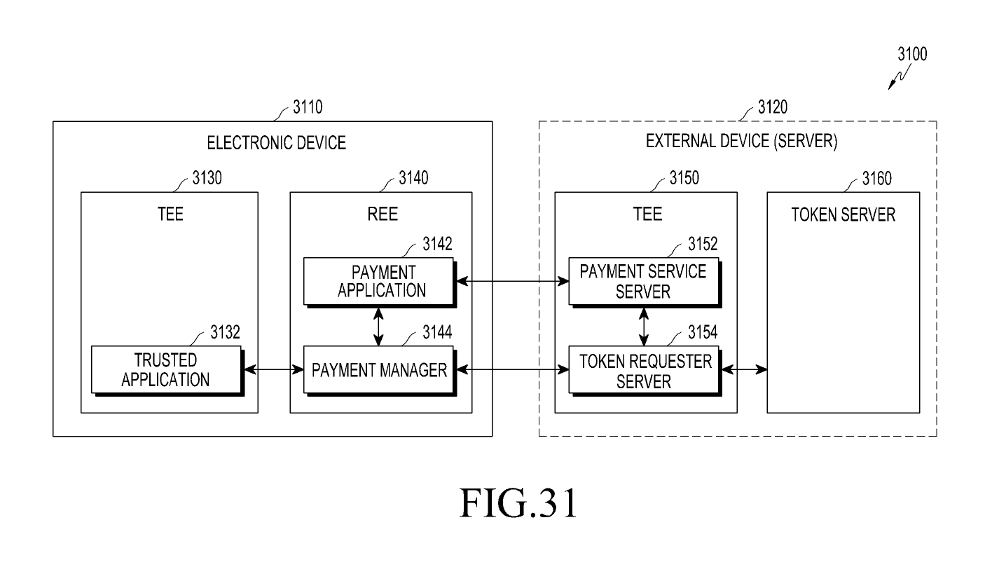

FIG. 31 is a view illustrating an example of a payment system, according to various embodiments of the present disclosure.

Referring to FIG. 31, the payment system 3100 may include an electronic device 3110 or an external device (e.g., a server) 3120.

The electronic device 3110 may include a trusted execution environment (TEE) 3130 and/or a rich OS environment (REE) 3140, and may further include additional configurations or circuits.

The TEE 3130 may include a secure system (e.g., a trusted application 3132) in relation to the electronic device 3110. For example, the electronic device 3110 may use the trusted application 3132 to protect information included or stored in the TEE 3130 from control in relation to an external request, modification, or input.

According to various embodiments of the present disclosure, the TEE 3130 may include a trusted program mode. For example, a normal world and a secure world may be separated using the TEE 3130. The normal world may include an REE 3140. In addition, the TEE 3130 may execute reliable applications, or may manage encrypted information. For example, the encrypted information may include token or key information.

According to various embodiments of the present disclosure, the TEE 3130 may protect the encrypted information from the outside. The token or key information may be used to encrypt the card information. For example, when providing the card information to the device for payment, at least some of the card information may be modified to then be provided to the device for payment, instead of directly providing the card information thereto, using the token or key information. The token or key information may be used in order to modify the card information. The key may be obtained from a service provider providing a payment service. The key may also be managed by the electronic device 3110 or the server.

According to various embodiments of the present disclosure, the TEE 3130 may include a trusted application 3132. For example, the TEE 3130 may provide an environment in which the trusted application can be executed.

According to various embodiments of the present disclosure, the trusted application 3132 may include information related to a card company, which is included in the TEE 3130. The card company-related information may include an application related to the card company, and the application may be provided in a packaged form. The packaged form may be provided as a software development kit (SDK).

According to various embodiments of the present disclosure, the trusted application 3132 may include an application or an applet that must be executed in a trusted mode such as the TEE 3130. The trusted application 3132 may also include an encryption-related function. For example, the trusted application 3132 may perform functions, such as cryptogram generation, modification, or deletion in relation to the payment.

The REE 3140 may include a payment application (wallet application) 3142, a payment manager 3144, or other application layers. For example, the REE 3140 may include an application and/or a framework. Unlike the TEE 3130, the REE 3140 may allow access and/or control from the outside.

The payment application 3142 may perform functions related to identity verification based on an interface or OCR for payment using the payment application 3142, card registration, or payment.

The payment manager 3144 may include information related to the card company, which is included in the REE 3140. The card company-related information may include an application related to the card company, and the application may be provided in a packaged form. The packaged form may be provided as the SDK.

According to various embodiments of the present disclosure, the payment manager 3144 may include an encryption-related function. For example, the payment manager 3144 may perform functions such as token ID management or establishment of a channel with a card company. The payment manager 3144 may also execute an interface with an external device 3120 (e.g., a server). For example, the payment manager 3144 may provide an interface with a server (e.g., the payment server 3150) for a tokenization service.

According to various embodiments of the present disclosure, the payment manager 3144 may be operatively connected to the trusted application 3132 to thus share information therewith. For example, the payment manager 3144 may execute an interface with the trusted application 3132 in order to use (for example, store) the token or the key. The trusted application 3132 may also include information related to a network provider.

According to various embodiments of the present disclosure, the payment application 3142 and the payment manager 3144 may be operatively connected to each other, and the trusted application 3132 and the payment manager 3144 may be operatively connected to each other. For example, the payment manager 3144 may transfer the information received from the outside to the payment application 3142 or the trusted application 3132, or may transfer the information received from the payment application 3142 or the trusted application 3132 to the outside.

According to various embodiments of the present disclosure, the payment manager 3144 may share information related to payment with the trusted application 3132 or the payment application 3142.

The external device 3120 may include a server, and the server may include a payment server 3150 and/or a token server 3160.

The payment server 3150 may include a payment service server 3152 or a token requester server 3154.

According to various embodiments of the present disclosure, the payment server 3150, which is a management server for electronic payment or mobile payment, may transmit and receive information related to payment (e.g., a token or a key) to and from the electronic device 3110. In addition, the payment service server 3152 and the token requester server 3154 included in the payment server 3150 may be operatively connected to share the payment-related information.

The token server 3160 may be operatively connected to the token requester server 3154 in order to thereby transmit and receive the payment-related information. For example, the token requester server 3154 and the token server 3160 may provide an interface for transferring the token or the key.

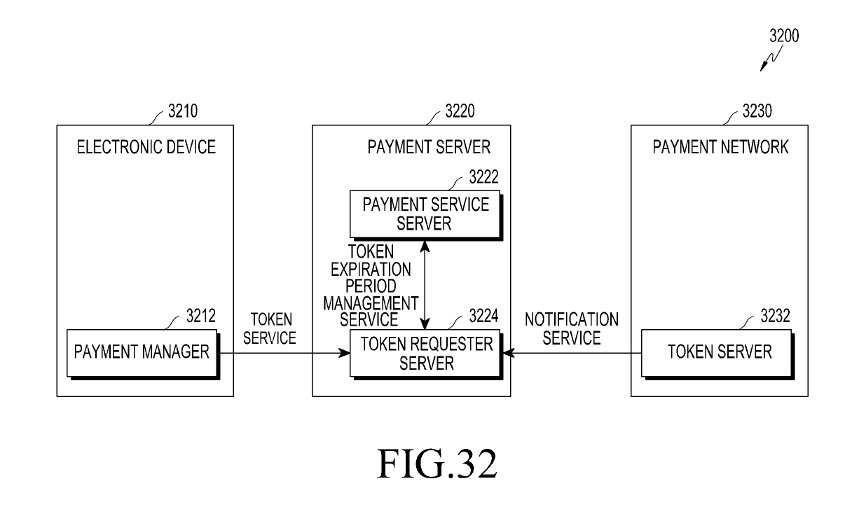

FIG. 32 is a view illustrating an example of a payment system, according to various embodiments of the present disclosure.

Referring to FIG. 32, the payment system 3200 may include an electronic device 3210, a payment server 3220, and/or a payment network 3230.

The electronic device 3210 may include a payment manager 3212.

The electronic device 3210 may provide a tokenization service in relation to the token using the payment manager 3212 included in the electronic device 3210 and the token requester server 3224 included in the payment server 3220.

The payment server 3220 may include a payment service server 3222 and/or a token requester server 3224.

The payment service server 3222 may provide a life cycle related to the token (e.g., token life management) using the token requester server 3224 included in the payment server 3220.

The token requester server 3224 may provide a payment method to the electronic device 3210 using a payment network solution. For example, the token requester server 3224 may determine a payment method suitable for the user using the tokenization service, the life cycle in relation to the token, and/or a notification service in relation to the token.

The payment network 3230 may include a token server 3232.

The token server 3232 may provide a notification service in relation to the token using the token requester server 3224.

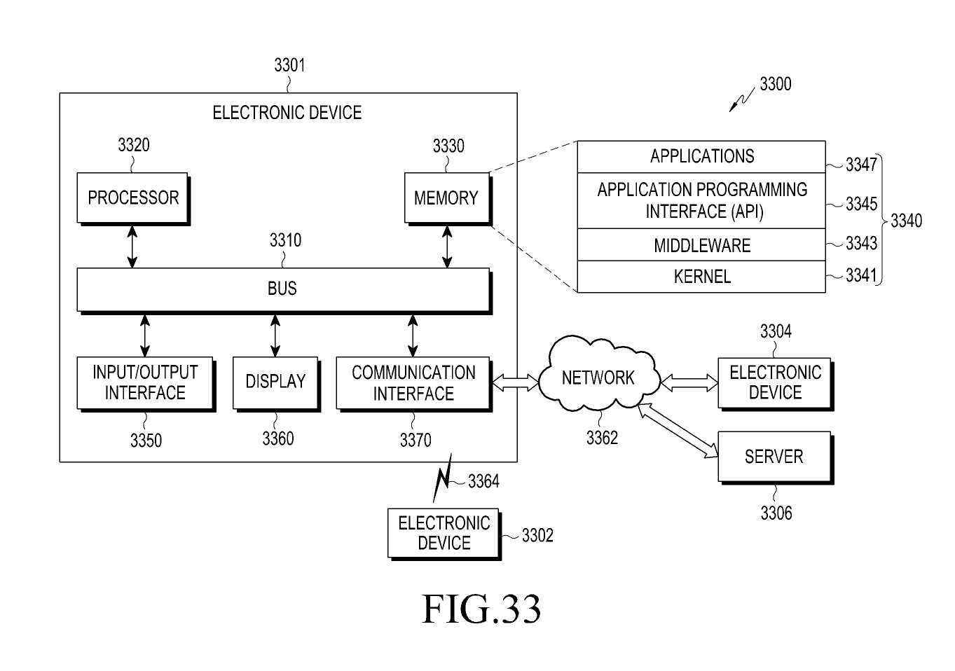

FIG. 33 is a view illustrating an example of a network environment, according to various embodiments of the present disclosure.

Referring to FIG. 33, the network environment 3300 may include an electronic device 3301 or at least one external device (e.g., a first electronic device 3302, a second electronic device 3304, or a server 3306), and the electronic device 3301 and the at least one external device may be connected through a network 3362 or through a Device-to-Device communication network 3364.

The electronic device 3301 may include a bus 3310, a processor 3320, a memory 3330, an input/output interface 3350, a display 3360, and a communication circuit 3370, and at least one of the elements may be omitted, or other elements may be further provided.

The bus 3310, for example, may include a circuit for connecting the elements 3310 to 3370 with each other and for transferring communication data (e.g., control messages and/or data) between the elements.

The processor 3320 may include at least one of a central processing unit (CPU), an application processor (AP), or a communication processor (CP). The processor 3320, for example, may process a calculation or data in relation to the control and/or communication of one or more other elements of the electronic device 3301.

The memory 3330 may include a volatile and/or non-volatile memory. For example, the memory 3330 may store commands or data in relation to one or more other elements of the electronic device 3301. According to an embodiment, the memory 3330 may store software and/or programs 3340. For example, the programs 3340 may include a kernel 3341, middleware 3343, an application programming interface (API) 3345, and/or application programs (or “applications”) 3347. At least some of the kernel 3341, the middleware 3343, or the API 3345 may be referred to as an operating system (OS).

The kernel 3341, for example, may control or manage system resources (e.g., the bus 3310, the processor 3320, or the memory 3330), which are used to execute the operation or function that is implemented in other programs (e.g., the middleware 3343, the API 3345, or the application programs 3347). In addition, the kernel 3341 may provide an interface by which the middleware 3343, the API 3345, or the application programs 3347 may access each element of the electronic device 3301 for the control or management of the system resources.

The middleware 3343, for example, may play the intermediate role between the API 3345 or the application programs 3347 and the kernel 3341 to communicate with each other for the transmission and reception of data.

In addition, the middleware 3343 may process one or more operation requests received from the application programs 3347 according to the priority. For example, the middleware 3343 may give priority for using the system resources (e.g., the bus 3310, the processor 3320, or the memory 3330) of the electronic device 3301 to at least one of the application programs 3347. For example, the middleware 3343 may perform scheduling or load balancing for the one or more operation requests by processing the one or more operation requests according to the priority given to at least one of the application programs.

For example, the API 3345, which is an interface by which the application programs 3347 control functions provided by the kernel 3341 or the middleware 3343, may include one or more interfaces or functions (e.g., instructions) for file control, window control, image processing, or text control.

The input/output interface 3350, for example, may play the role of an interface for transferring commands or data received from a user or other external devices to other elements of the electronic device 3301. The input/output interface 3350 may also output commands or data received from the other elements of the electronic device 3301 to the user or other external devices.

The display 3360, for example, may include a liquid crystal display (LCD), a light-emitting diode (LED) display, an organic light-emitting diode (OLED) display, a micro-electromechanical system (MEMS) display, or an electronic paper display. For example, the display 3360 may display a variety of content (e.g., text, images, videos, icons, symbols, or the like) to the user. The display 3360 may include a touch screen, and, for example, may receive a touch input, a gesture input, a proximity input, or a hovering input using electronic pens or a user's body part.

The communication circuit 3370, for example, may establish communication between the electronic device 3301 and an external device (e.g., a first external electronic device 3302, a second external electronic device 3304, or a server 3306). For example, the communication circuit 3370 may be connected to the network 3362 through wireless communication or wired communication in order to thereby communicate with the external device (e.g., the second external electronic device 3304 or the server 3306).

For example, the wireless communication may use, as a cellular communication protocol, at least one of LTE (long-term evolution), LTE-A (LTE Advance), CDMA (code division multiple access), WCDMA (wideband CDMA), a UMTS (universal mobile telecommunications system), WiBro (Wireless Broadband), GSM (Global System for Mobile Communications), or the like. In addition, the wireless communication, for example, may include short-range communication 3364. The short-range communication 3364, for example, may include at least one of Wi-Fi (wireless fidelity), Bluetooth, NFC (near field communication), MST (magnetic stripe transmission), or a GNSS (global navigation satellite system).

The MST may generate a pulse according to transmission data using an electromagnetic signal, and the pulse may generate a magnetic-field signal. The electronic device 3301 may transmit the magnetic-field signal to a POS device, and the POS device may detect the magnetic-field signal using an MST reader, and may convert the detected magnetic-field signal into an electric signal in order to thereby recover the data.

The GNSS, for example, may include at least one of a GPS (Global Positioning System), a Glonass (Global Navigation Satellite System), the Beidou Navigation Satellite System (hereinafter, “Beidou”), Galileo, or the European global satellite-based navigation system according to the usage area or bandwidth. Hereinafter, “GPS” may be used interchangeably with “GNSS” in the present specification.

The wired communication, for example, may include at least one of a universal serial bus (USB), a high-definition multimedia interface (HDMI), recommended standard 232 (RS-232), or a plain old telephone service (POTS). The network 3362 may include at least one of the telecommunication networks, such as a computer network (e.g., LAN or WAN), the Internet, or a telephone network.

The first external electronic device 3302 and the second external electronic device 3304 may be the same as, or different from, the electronic device 3301 as to the type thereof. According to an embodiment, the server 3306 may include a group of one or more servers. According to various embodiments, at least some, or all, of the operations executed in the electronic device 3301 may be executed by one or more other electronic devices (e.g., the electronic device 3302 or 3304, or the server 3306). According to an embodiment, in the case where the electronic device 3301 executes a specific function or service automatically or upon request, the electronic device 3301 may make a request to other devices (e.g., the electronic device 3302 or 3304, or the server 3306) for at least some of the functions related to the function or service additionally, or instead of, executing the same by itself. The other electronic devices (e.g., the electronic device 3302 or 104, or the server 3306) may execute the requested function or additional function, and may transfer the result of the execution to the electronic device 3301. The electronic device 3301 may provide the requested function or service by providing the result without change or by additionally processing the same. To this end, for example, cloud computing, distributed computing, or client-server computing technology may be used.

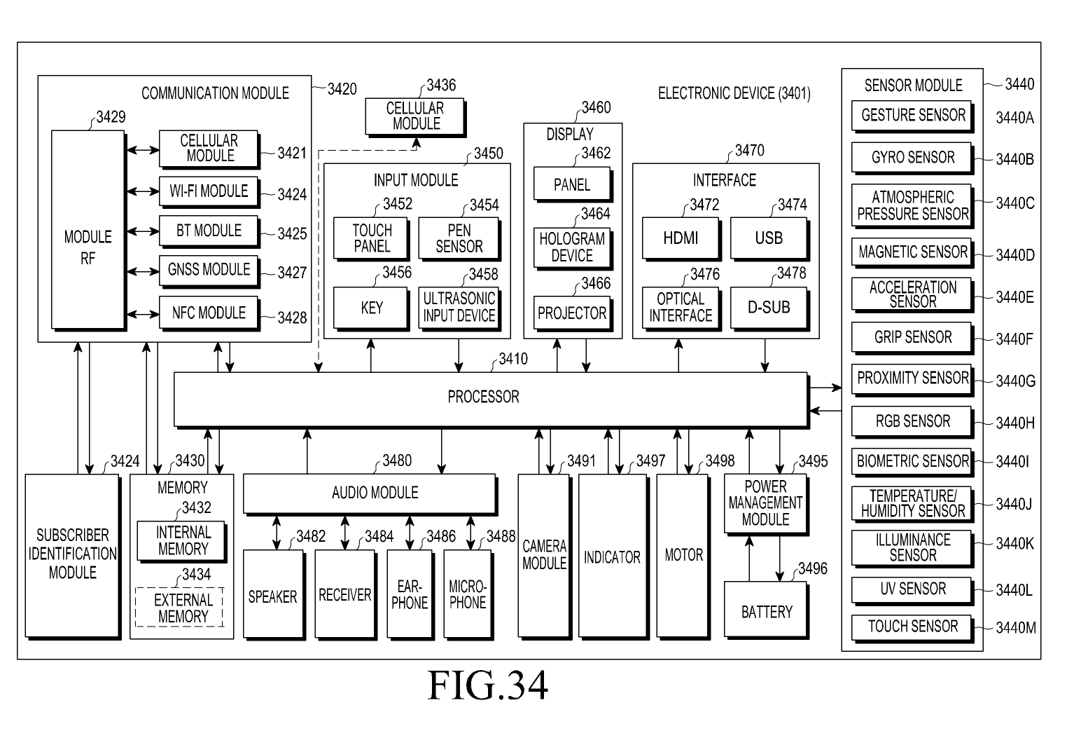

FIG. 34 is a block diagram illustrating an example of the configuration of an electronic device, according to various embodiments of the present disclosure.

Referring to FIG. 34, the electronic device 3401 may include all or some of the elements of the electronic device 3301 shown in FIG. 33.

The electronic device 3401 may include one or more processors {e.g., application processors (AP)} 3410, a communication circuit 3420, a subscriber identification module 3424, a memory 3430, a sensor circuit 3440, an input device 3450, a display 3460, an interface 3470, an audio circuit 3480, a camera circuit 3491, a power management circuit 3495, a battery 3496, an indicator 3497, or a motor 3498.

The processor 3410, for example, may control a multitude of hardware or software elements connected with the processor 3410, and may perform the processing of various pieces of data and a calculation by executing an operating system or application programs. The processor 3410 may be implemented by, for example, a system on chip (SoC). According to an embodiment, the processor 3410 may further include a graphic processing unit (GPU) and/or an image signal processor. The processor 3410 may include at least some (e.g., a cellular circuit 3421) of the elements shown in FIG. 34. The processor 3410 may load commands or data received from one or more other elements (e.g., a non-volatile memory) to a volatile memory to then process the same, and may store a variety of data in a non-volatile memory.

The communication circuit 3420 may have a configuration the same as or similar to that of the communication circuit 3370 of FIG. 33. The communication circuit 3420, for example, may include a cellular circuit 3421, a Wi-Fi circuit 3422, a Bluetooth circuit 3423, a GNSS circuit 3424 (e.g., a GPS circuit, a Glonass circuit, a Beidou circuit, or a Galileo circuit), an NFC circuit 3425, an MST circuit 3426, and a radio frequency (RF) circuit 3427.

The cellular circuit 3421, for example, may be configured to provide services of voice calls, video calls, text messaging, or the Internet through communication networks. According to an embodiment, the cellular circuit 3421 may perform identification and verification of the electronic device 3401 in communication networks using the subscriber identification circuit (e.g., a SIM card) 3429. According to an embodiment, the cellular circuit 3421 may be configured to perform at least some of the functions provided by the processor 3410. According to an embodiment, the cellular circuit 3421 may include a communication processor (CP).

For example, each of the Wi-Fi circuit 3422, the Bluetooth circuit 3423, the GNSS circuit 3424, the NFC circuit 3425, or the MST circuit 3426 may include a processor for processing data transmitted and received through the corresponding circuit. According to an embodiment, at least some (e.g., two or more) of the cellular circuit 3421, the Wi-Fi circuit 3422, the Bluetooth circuit 3423, the GNSS circuit 3424, the NFC circuit 3425, or the MST circuit 3426 may be included in one integrated chip (IC) or one IC package.

The RF circuit 3427 may transmit and receive communication signals (e.g., RF signals). The RF circuit 3427 may include, for example, a transceiver, a power amp circuit (PAM), a frequency filter, a low-noise amplifier (LNA), antennas, or the like. According to another embodiment, at least one of the cellular circuit 3421, the Wi-Fi circuit 3422, the Bluetooth circuit 3423, the GNSS circuit 3424, the NFC circuit 3425, or the MST circuit 3426 may transmit and receive RF signals through a separate RF circuit.

The subscriber identification circuit 3429, for example, may include a card and/or an embedded SIM adopting a subscriber identification circuit, and may contain inherent identification information {e.g., an integrated circuit card identifier (ICCID)} or subscriber information {e.g., an international mobile subscriber identity (IMSI)}.

The memory 3430 (e.g., the memory 3330), for example, may include an internal memory 3432 or an external memory 3434. The internal memory 3432, for example, may include at least one of volatile memories {e.g., a dynamic RAM (DRAM), a static RAM (SRAM), a synchronous dynamic RAM (SDRAM), or the like} or non-volatile memories {e.g., an one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard drive, a solid state drive (SSD), or the like}.

The external memory 3434 may further include a flash drive such as compact flash (CF), secure digital (SD), micro secure digital (Micro-SD), mini secure digital (Mini-SD), extreme digital (xD), a multi-media card (MMC), a memory stick, or the like. The external memory 3434 may be functionally and/or physically connected with the electronic device 3401 through any of various interfaces.

A secure circuit 3436 may include a storage space of which the security level is relatively higher than that of the memory 3430, and may guarantee safe data storage and a trusted execution environment. The secure circuit 3436 may be implemented by a separate circuit, or may include a separate processor. The secure circuit 3436, for example, may be included in detachable smart chips or in secure digital (SD) cards, or may include an embedded secure element (eSE) that is embedded in a fixed chip of the electronic device 3401. In addition, the secure circuit 3436 may be operated by an operating system (OS) that is different from the operating system of the electronic device 3401. For example, the secure circuit may be operated based on a java card open platform (JCOP) operating system.

The sensor circuit 3440, for example, may measure physical quantities, or may detect the operation state of the electronic device 3401 to thereby convert the measured or detected information to electric signals. The sensor circuit 3440 may include at least one of, for example, a gesture sensor 3440A, a gyro-sensor 3440B, an atmospheric pressure sensor 3440C, a magnetic sensor 3440D, an acceleration sensor 3440E, a grip sensor 3440F, a proximity sensor 3440G, a color sensor 3440H {e.g., a red-green-blue (RGB) sensor}, a biometric sensor 3440I, a temperature/humidity sensor 3440J, an illuminance sensor 3440K, or an ultra-violet (UV) sensor 3440M. Alternatively or additionally, the sensor circuit 3440, for example, may further include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor circuit 3440 may further include a control circuit for controlling one or more sensors included therein. In some embodiments, the electronic device 3401 may further include a processor, which is configured to control the sensor circuit 3440, as a part of the processor 3410 or separately from the processor 3410 in order to thereby control the sensor circuit 3440 while the processor 3410 is in a sleep mode.

The input device 3450, for example, may include a touch panel 3452, a (digital) pen sensor 3454, keys 3456, or an ultrasonic input device 3458. The touch panel 3452 may use at least one of, for example, a capacitive type, a pressure-sensitive type, an infrared type, or an ultrasonic type. In addition, the touch panel 3452 may further include a control circuit. The touch panel 3452 may further include a tactile layer in order to thereby provide a user with a tactile reaction.

For example, the (digital) pen sensor 3454 may be a part of the touch panel, or may include a separate recognition sheet. The keys 3456 may include, for example, physical buttons, optical keys, or a keypad. The ultrasonic input device 3458 may detect ultrasonic waves generated in the input means through a microphone (e.g., a microphone 3488), thereby identifying data corresponding to the detected ultrasonic waves.

The display 3460 (e.g., the display 3360) may include a panel 3462, a hologram device 3464, or a projector 3466. The panel 3462 may include the configuration the same as, or similar to, that of the display 3360 of FIG. 33. The panel 3462 may be implemented to be, for example, flexible, transparent, or wearable. The panel 3462 may be configured with the touch panel 3452 as a single circuit. The hologram device 3464 may display 3D images in the air using light interference. The projector 3466 may display images by projecting light onto a screen. The screen may be positioned, for example, inside or outside the electronic device 3401. According to an embodiment, the display 3460 may further include a control circuit for controlling the panel 3462, the hologram device 3464, or the projector 3466.

The interface 3470 may include, for example, a high-definition multimedia interface (HDMI) 3472, a universal serial bus (USB) 3474, an optical interface 3476, or a D-subminiature (D-sub) interface 3478. The interface 3470, for example, may be included in the communication circuit 3370 shown in FIG. 33. Additionally or alternatively, the interface 3470 may include, for example, a mobile high-definition link (MHL) interface, a secure digital (SD) card/multi-media card (MMC) interface, or an infrared data association (IrDA) standard interface.

The audio circuit 3480, for example, may be configured to convert a sound into an electric signal, and vice versa. At least some elements of the audio circuit 3480 may be included, for example, in the input/output interface 3345 shown in FIG. 33. For example, the audio circuit 3480 may be configured to process voice information that is input or output through a speaker 3482, a receiver 3484, earphones 3486, or a microphone 3488.

For example, the camera circuit 3491, which is a device for photographing still and moving images, may include one or more image sensors (e.g., a front sensor or a rear sensor), lenses, an image signal processor (ISP), or a flash (e.g., an LED or a xenon lamp) according to an embodiment.

The power management circuit 3495, for example, may manage the power of the electronic device 3401. According to an embodiment, the power management circuit 3495 may include a power management integrated circuit (PMIC), a charger integrated circuit (IC), or a battery or fuel gauge. The PMIC may be implemented by a wired charging type and a wireless charging type. The wireless charging type may encompass, for example, a magnetic resonance type, a magnetic induction type, or an electromagnetic wave type, and additional circuits for wireless charging, such as coil loops, resonance circuits, or rectifiers, may be further provided. The battery gauge may measure, for example, the remaining power of the battery 3496, a charging voltage, current, or temperature. The battery 3496 may include, for example, a rechargeable battery or a solar battery.

The indicator 3497 may display a specific state (e.g., a booting state, a message state, or a charging state) of the whole or a part (e.g., the processor 3410) of the electronic device 3401. The motor 3498 may convert an electric signal to a mechanical vibration, and may provide a vibration or a haptic effect. Although it is not shown in the drawing, the electronic device 3401 may include a processing device (e.g., a GPU) for supporting mobile TV. The processing device for supporting mobile TV may process media data according to standards such as, for example, Digital Multimedia Broadcasting (DMB), Digital Video Broadcasting (DVB), or mediaFlo™.

Each of the above-described component elements of hardware according to the present disclosure may be configured with one or more components, and the names of the corresponding component elements may vary based on the type of electronic device. In various embodiments, the electronic device may include at least one of the above-described elements. Some of the above-described elements may be omitted from the electronic device, or the electronic device may further include additional elements. Also, some of the hardware components according to various embodiments may be combined into one entity, which may perform functions identical to those of the relevant components before the combination.

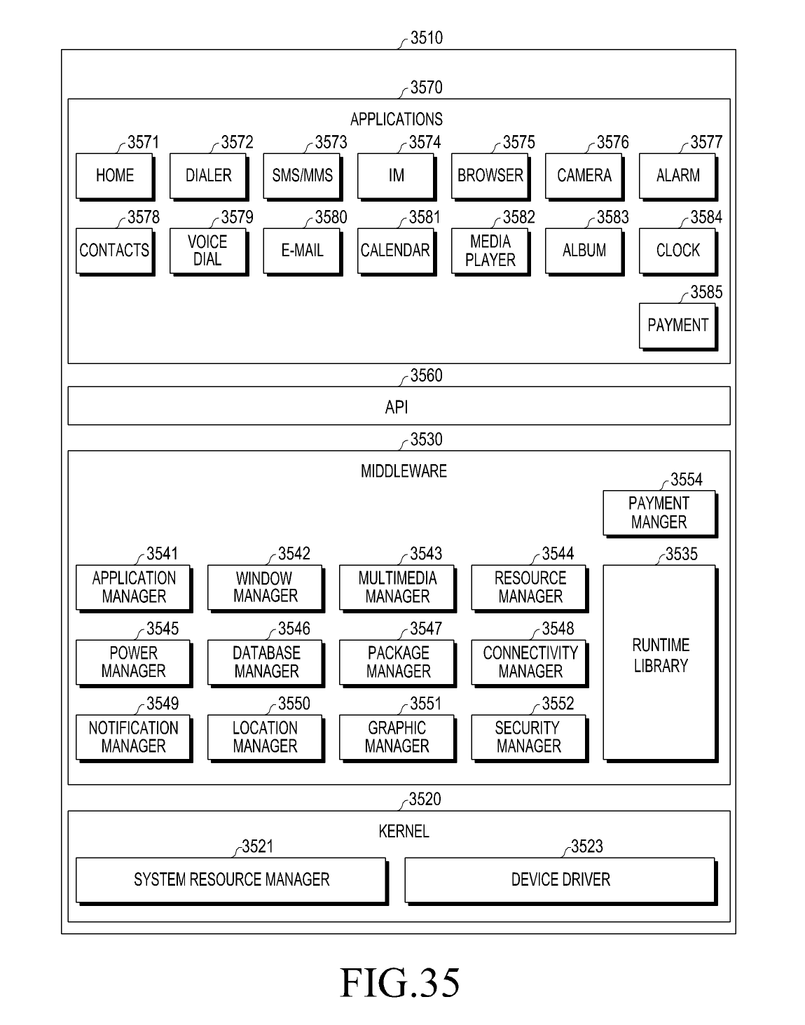

FIG. 35 is a block diagram illustrating an example of a program circuit, according to various embodiments of the present disclosure.

Referring to FIG. 35, the program circuit 3510 (e.g., the programs 3340) may include an operating system (OS) for controlling resources related to the electronic device (e.g., the electronic device 3301) and/or various applications (e.g., the application programs 3347) operated under the operating system. For example, the operating system may be Android, iOS, Windows, Symbian, Tizen, Bada, or the like.

The program circuit 3510 may include a kernel 3520, middleware 3530, an application programming interface (API) 3560, and/or applications 3570. At least some of the program circuit 3510 may be preloaded in the electronic device, or may be downloaded from external electronic devices (e.g., the electronic devices 3302 and 3304 or the server 3306).

The kernel 3520 (e.g., the kernel 3341), for example, may include a system resource manager 3521 and/or a device driver 3523. The system resource manager 3521 may perform control, allocation, or collection of the system resources. According to an embodiment, the system resource manager 3521 may include a process management unit, a memory management unit, or a file system management unit. The device driver 3523 may include, for example, a display driver, a camera driver, a Bluetooth driver, a shared-memory driver, a USB driver, a keypad driver, a Wi-Fi driver, an audio driver, or an inter-process communication (IPC) driver.

The middleware 3530, for example, may provide functions required in common for the applications 3570, or may provide the applications 3570 with various functions through the API 3560 in order to allow the applications 3570 to effectively use the limited system resources in the electronic device. According to an embodiment, the middleware 3530 (e.g., the middleware 3343) may include at least one of a runtime library 3535, an application manager 3541, a window manager 3542, a multimedia manager 3543, a resource manager 3544, a power manager 3545, a database manager 3546, a package manager 3547, a connectivity manager 3548, a notification manager 3549, a location manager 3550, a graphic manager 3551, a security manager 3552, or a payment manager 3554.

The runtime library 3535, for example, may include a library circuit that a compiler uses in order to add new functions through programming languages while the applications 3570 are executed. The runtime library 3535 may perform the input/output management, the memory management, or a function of an arithmetic calculation.

The application manager 3541, for example, may manage a life cycle of at least one of the applications 3570. The window manager 3542 may manage a GUI resource used in the screen. The multimedia manager 3543 may identify formats for reproducing various media files, and may perform encoding or decoding of media files using a codec corresponding to each format. The resource manager 3544 may manage resources, such as source codes, memories, or storage spaces of one or more applications 3570.

The power manager 3545, for example, may manage a battery or power by operating in association with a basic input/output system (BIOS), and may provide power information necessary for the operation of the electronic device. The database manager 3546 may manage to create, retrieve, or change a database to be used in one or more applications 3570. The package manager 3547 may manage the installation or update of the applications that are distributed in the form of a package file.

The connectivity manager 3548, for example, may manage a wireless connection, such as Wi-Fi or Bluetooth. The notification manager 3549 may display or notify of events, such as received messages, appointments, or proximity notifications, to the user without disturbance. The location manager 3550 may manage locational information of the electronic device. The graphic manager 3551 may manage graphic effects or a user interface related thereto, which will be provided to the user. The security manager 3552 may provide a general security function required for the system security or user verification. According to an embodiment, in the case of an electronic device (e.g., the electronic device 3301) adopting a phone call function, the middleware 3530 may further include a telephony manager for managing a function of a voice call or a video call of the electronic device. The payment manager 3554 may relay information for payment from the applications 3570 to the applications 3570 or kernel 3520. In addition, the payment manager 3554 may store payment-related information received from the external device in the electronic device 200, or may transfer the information stored therein to the external device.

The middleware 3530 may include a middleware circuit by means of a combination of various functions of the above-described elements. The middleware 3530 may provide a circuit that is specialized according to the type of operating system in order to provide differentiated functions. In addition, the middleware 3530 may dynamically exclude some of the typical elements or add new elements.

The API 3560 (e.g., the API 3345), for example, may be a group of API programming functions, and may be provided as a different configuration according to an operating system. For example, one set of APIs may be provided to each platform in the case of Android or iOS, and two or more sets of APIs may be provided to each platform in the case of Tizen.

The applications 3570 (e.g., the application programs 3347) may include one or more applications that execute functions of home 3571, a dialer 3572, SMS/MMS 3573, instant messages (IM) 3574, a browser 3575, a camera 3576, an alarm 3577, contacts 3578, a voice dialer 3579, e-mail 3580, a calendar 3581, a media player 3582, an album 3583, a clock 3584, payment 3585, healthcare (for example, measuring the amount of exercise or blood glucose), providing environment information (for example, providing atmospheric pressure, humidity, or temperature information), or the like.

According to various embodiments of the present document, the applications 3570 may include an application (hereinafter, referred to as “information-exchange application” for the convenience of explanation) that supports the exchange of information between the electronic device (e.g., the electronic device 3301) and the external electronic device (e.g., the electronic device 3302 or 3304). The information-exchange application, for example, may include a notification relay application for relaying specific information to the external electronic device or a device management application for managing the external electronic device.

For example, the notification relay application may include a function of transferring notification information generated in other applications (e.g., the SMS/MMS application, the e-mail application, the healthcare application, or the environment information application) of the electronic device to the external electronic device (e.g., the electronic device 3302 or 3304). In addition, the notification relay application, for example, may receive notification information from the external electronic device to then provide the same to the user.

The device management application, for example, may manage (e.g., install, delete, or update) one or more functions {e.g., turning on and off the external electronic device (or some elements) or adjusting the brightness (or resolution) of a display} of the external electronic device (e.g., the electronic device 3302 or 3304) that communicates with the electronic device, applications executed in the external electronic device, or services (e.g., a phone call service or a messaging service) provided by the external electronic device.

According to various embodiments of the present document, the applications 3570 may include applications that are specified according to the attributes (e.g., the healthcare application of a mobile medical device) of the external electronic device (e.g., the electronic device 3302 or 3304). According to an embodiment, the applications 3570 may include applications received from the external electronic device (e.g., the server 3306 or the electronic device 3302 or 3304). According to an embodiment, the applications 3570 may include preloaded applications or third party applications that can be downloaded from a server. The names of the elements of the program circuit 3510, according to the illustrated embodiment, may vary depending on the type of operating system.

According to various embodiments of the present document, at least some of the program circuit 3510 may be implemented by software, firmware, hardware, or a combination thereof. At least some of the program circuit 3510, for example, may be implemented (for example, executed) by the processor (e.g., the processor 3320). At least some of the program circuit 3510, for example, may include modules, circuits, programs, routines, sets of instructions, or processors for executing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 3320), may cause the one or more processors to execute the function corresponding to the instruction. The computer-readable storage medium may be, for example, the memory 3330.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware electronic device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Furthermore, some operations may be executed in a different order or may be omitted, or other operations may be added. Various embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

1. An electronic device comprising:
at least one communication circuit;
a memory configured to store verification information; and
a processor configured to perform control so as to transmit, to a payment device, payment data, which is generated using the verification information, through a first communication circuit in response to a payment request input through the electronic device, configured to check whether or not a payment response message including information related to payment execution using the payment data is received through a second communication circuit, and configured to manage the stored verification information depending on whether or not the payment response message is received within a predetermined time, wherein
the first communication circuit is configured to transmit the payment data in a magnetic stripe transmission (MST) manner.

2. The electronic device of claim 1, wherein the verification information includes key information for decrypting a cryptogram included in the payment data,
wherein the information related to the payment execution includes information indicating whether or not the first verification information has been used for the payment request, and
wherein the payment response message includes at least one piece of verification information used for payment, newly issued verification information, payment amount information, or payment execution result information.

3. The electronic device of claim 1, wherein the processor, if the payment response message is received within a predetermined time, confirms whether or not the payment using the payment data has been performed by checking the received payment response message, and, if it is confirmed that the payment using the payment data has been performed, performs control so as to delete the first verification information from the stored verification information.

4. The electronic device of claim 3, wherein the processor identifies the number of pieces of the stored verification information to thus make a request to a server for issuing new verification information through the second communication circuit, receives newly issued verification information through the second communication circuit in response to the request for new verification information, and stores at least one piece of the received verification information in the memory to thus manage the stored verification information.

5. The electronic device of claim 4, wherein the processor performs control so as to transmit identification information of the electronic device through the second communication circuit for communication with the server, and
wherein the identification information of the electronic device includes at least one of a telephone number, an internet protocol (IP) address, or a media access control (MAC) address of the electronic device.

6. The electronic device of claim 4, wherein the processor performs control so as to perform communication with the server through a secure channel.

7. The electronic device of claim 1, wherein the processor manages the stored verification information such that the first verification information is not to be deleted if the payment response message is not received within a predetermined time.

8. The electronic device of claim 7, wherein the processor performs control so as to generate second payment data using the first verification information when second payment is requested, and so as to transmit the generated second payment data to the payment device through the first payment circuit.

9. A method of performing a payment transaction in an electronic device, the method comprising:
transmitting, to a payment device, payment data generated using verification information in response to a payment request input through the electronic device;
checking whether or not a payment response message including payment execution result information using the payment data is received; and
managing stored verification information depending on whether or not the payment response message is received within a predetermined period of time, wherein
the payment data is transmitted in a magnetic stripe transmission (MST) manner.

10. The method of claim 9, wherein the verification information includes key information for decrypting a cryptogram included in the payment data,
wherein the information related to the payment execution includes information indicating whether or not first verification information has been used for the payment request, and
wherein the payment response message includes at least one piece of verification information used for payment, newly issued verification information, payment amount information, or payment execution result information.

11. The method of claim 9, further comprising:
if the payment response message is received within a predetermined period of time, confirming whether or not the payment using the payment data has been performed by checking the received payment response message; and
if it is confirmed that the payment using the payment data has been performed, deleting first verification information from the stored verification information.

12. The method of claim 11, further comprising:
making a request to a server for issuing new verification information by identifying the number of pieces of the stored verification information;
receiving newly issued verification information in response to the request for new verification information; and
storing at least one piece of the received verification information in a memory to thus manage the stored verification information.

13. The method of claim 12, further comprising:
transmitting identification information of the electronic device through communication with the server; and
performing communication with the server through a secure channel, wherein
the identification information of the electronic device includes at least one of a telephone number, an internet protocol (IP) address, or a media access control (MAC) address of the electronic device.

14. The method of claim 9, further comprising managing the stored verification information such that first verification information is not to be deleted if the payment response message is not received within a predetermined period of time.

15. The method of claim 14, further comprising
generating second payment data using the first verification information when second payment is requested; and
transmitting the generated second payment data to the payment device.
